(19) United States
(12) Patent Application Publication
(10) Pub. No.: US 2025/0180856 A1
(43) Pub. Date: Jun. 5, 2025

(54) LENS DEVICE

(71) Applicant: FUJIFILM Corporation, Tokyo (JP)

(72) Inventors: Takeya ABE, Saitama (JP); Hajime FUKUSHIMA, Saitama (JP); Yasuhiro MORI, Saitama (JP)

(73) Assignee: FUJIFILM Corporation, Tokyo (JP)

(21) Appl. No.: 19/052,281

(22) Filed: Feb. 13, 2025

Related U.S. Application Data
(63) Continuation of application No. PCT/JP2023/025265, filed on Jul. 7, 2023.

(30) Foreign Application Priority Data
Aug. 25, 2022 (JP) 2022-134039

(51) Int. Cl. G02B 7/04; G03B 17/14

(52) U.S. Cl. CPC G02B 7/04; G03B 17/14

(57) ABSTRACT

A lens device includes a movable frame movable in an extending direction of an optical axis, a first driving unit that drives the movable frame, and a restriction mechanism that restricts movement of the movable frame. The restriction mechanism includes a rotational movement member rotationally movable between a first position and a second position around a rotational axis extending in the extending direction, a first engagement portion that is provided at one of the movable frame or the rotational movement member and is elastically deformed, and a second engagement portion that is provided at the other of the movable frame or the rotational movement member and is engaged with the first engagement portion. At the first position, the first and the second engagement portions are separated from each other. At the second position, the first and the second engagement portions are engaged with each other, while being deformed.

### CROSS-REFERENCE TO RELATED APPLICATIONS

The present application is a Continuation of PCT International Application No. PCT/JP2023/025265 filed on Jul. 7, 2023 claiming priority under 35 U.S.C § 119 (a) to Japanese Patent Application No. 2022-134039 filed on Aug. 25, 2022. Each of the above applications is hereby expressly incorporated by reference, in its entirety, into the present application.

### BACKGROUND OF THE INVENTION

### 1. Field of the Invention

The present invention relates to a lens device, and particularly to a lens device including a movable frame and a restriction mechanism that restricts movement of the movable frame.

### 2. Description of the Related Art

A lens device in which a movable lens group such as a zoom lens group and a focus lens group is driven by means of a linear motor such as a voice coil motor (VCM) is known.

Described in JP2019-109427A, JP2017-3742A, and JP2010-271607A are lens devices in each of which movement of a movable lens group can be prevented even in a state where a linear motor is not electrified.

### SUMMARY OF THE INVENTION

An embodiment according to the present disclosed technology provides a lens device with which it is possible to restrict movement of a movable frame.

(1) A lens device including a movable frame that is movable in an extending direction of an optical axis, a first driving unit that drives the movable frame, and a restriction mechanism that restricts movement of the movable frame, in which the restriction mechanism includes a rotational movement member that is rotationally movable between a first position and a second position around a rotational axis extending in the extending direction, a first engagement portion that is provided at one of the movable frame or the rotational movement member and that is elastically deformed, and a second engagement portion that is provided at the other of the movable frame or the rotational movement member and that is engaged with the first engagement portion, the first position is a position at which the first engagement portion and the second engagement portion are separated from each other, and the second position is a position at which the first engagement portion is engaged with the second engagement portion while being elastically deformed.

(2) The lens device according to (1), in which the first driving unit is a driving unit that allows the movable frame to move freely in a case of a non-electrified state.

(3) The lens device according to (1) or (2), in which the first driving unit is a linear motor.

(4) The lens device according to any one of (1) to (3), in which the first position is a position in a case of an electrified state of the first driving unit, and the second position is a position in a case of a non-electrified state of the first driving unit.

(5) The lens device according to any one of (1) to (4), in which the first position is a position at which the movable frame restricted from moving is released, and the second position is a position at which the movement of the movable frame is restricted.

(6) The lens device according to any one of (1) to (5), further including a second driving unit that rotationally moves the rotational movement member.

(7) The lens device according to any one of (1) to (6), in which the first engagement portion has a recessed shape, and the second engagement portion has a protruding shape.

(8) The lens device according to any one of (1) to (7), in which, in a case where the rotational movement member is rotationally moved from the first position to the second position, the second engagement portion is engaged with the first engagement portion with the first engagement portion being elastically deformed and thus the restriction mechanism restricts the movement of the movable frame and in a case where the rotational movement member is rotationally moved from the second position to the first position, the second engagement portion is separated from the first engagement portion with the first engagement portion being elastically deformed and thus the restriction mechanism releases the movable frame restricted from moving.

(9) The lens device according to any one of (1) to (8), in which the first engagement portion is provided at the rotational movement member, and the second engagement portion is provided at the movable frame.

(10) The lens device according to any one of (1) to (9), in which the movable frame includes a first guide portion that slides in a first axial direction extending in the extending direction and that guides the movement of the movable frame, and a second guide portion that slides in a second axial direction extending in the extending direction and that assists in guidance performed by the first guide portion, and the first engagement portion or the second engagement portion is provided relatively closer to the first guide portion than to the second guide portion.

(11) The lens device according to any one of (1) to (10), in which each of portions of the first engagement portion and the second engagement portion at which the first engagement portion and the second engagement portion are engaged with each other has a shape including an arc around the rotational axis of the rotational movement member in a cross section intersecting the optical axis.

(12) The lens device according to any one of (1) to (11), in which the first engagement portion includes a first protruding portion and a second protruding portion that are disposed at an interval in the extending direction, and the second engagement portion includes a third protruding portion that is engaged with the interval.

(13) The lens device according to (12), in which a width of the third protruding portion in the extending direction is larger than the interval.

(14) The lens device according to (12) or (13), in which each of the first protruding portion and the second protruding portion has a shape of which a width in the extending direction decreases from the rotational axis toward an outer side.

(15) The lens device according to any one of (12) to (14), in which surfaces of the first protruding portion and the second protruding portion that face each other are inclined such that the interval becomes greater from the second position toward the first position.

(16) The lens device according to (15), further including a biasing member or a biasing mechanism that biases the rotational movement member in a direction from the first position toward the second position.

(17) The lens device according to any one of (12) to (15), in which the third protruding portion has a shape of which a width decreases in a direction from the first position toward the second position.

(18) The lens device according to (17), further including a biasing member or a biasing mechanism that biases the rotational movement member in a direction from the first position toward the second position.

(19) The lens device according to any one of (12) to (18), in which corner portions of the first protruding portion and the second protruding portion that come into contact with the third protruding portion include chamfered portions.

(20) The lens device according to any one of (12) to (19), in which end portions of the first protruding portion and the second protruding portion that are on a movable frame side or a rotational movement member side include chamfered portions.

(21) The lens device according to any one of (12) to (20), in which at least one of the first protruding portion or the second protruding portion includes an elastic member.

(22) The lens device according to (6), in which the second driving unit includes a cam groove that is provided at the rotational movement member, a screw member that is disposed to extend in the extending direction, an actuator that rotationally drives the screw member, a sliding member that slides in the extending direction, a nut portion that is provided at the sliding member and that is screw-bonded to the screw member, and a cam pin that is provided at the sliding member and that is engaged with the cam groove, and a linear motion of the sliding member is converted into a rotational motion by means of the cam pin and the cam groove so that the rotational movement member is rotationally moved.

(23) The lens device according to (6), in which the second driving unit includes a cam groove that is provided at the rotational movement member, a screw member that is disposed to extend in the extending direction, an actuator that rotationally drives the screw member, a first sliding member that slides in the extending direction, a second sliding member that slides in the extending direction, a restriction member that is engaged with the first sliding member and the second sliding member and that restricts a movable range of the first sliding member with respect to the second sliding member, a cam pin that is provided at the first sliding member and that is engaged with the cam groove, a nut portion that is provided at the second sliding member and that is screw-bonded to the screw member, and a biasing member that is provided between the first sliding member and the second sliding member and that biases the first sliding member and the second sliding member in directions away from each other, and a linear motion of the first sliding member is converted into a rotational motion by means of the cam pin and the cam groove so that the rotational movement member is rotationally moved.

(24) The lens device according to (23), in which the first engagement portion includes a fourth protruding portion and a fifth protruding portion that are disposed at an interval in the extending direction, and surfaces of the fourth protruding portion and the fifth protruding portion that face each other are inclined such that an interval between the surfaces facing each other becomes greater from the first position toward the second position.

(25) The lens device according to (23) or (24) in which the second engagement portion includes a sixth protruding portion that is engaged with the first engagement portion, and the sixth protruding portion has a shape of which a width decreases in a direction from the first position toward the second position.

### BRIEF DESCRIPTION OF THE DRAWINGS

FIG. 1 is an exploded view of a focus lens unit.

FIG. 2 is a view showing an internal structure of a lens barrel.

FIG. 3 is a perspective view showing a configuration of a movable frame driving unit.

FIG. 4 is a view showing a configuration of a position detection unit.

FIG. 5 is a view showing a configuration of a main part of a restriction mechanism.

FIG. 6 is a view showing a configuration of a lock lever.

FIG. 7 is a view showing a configuration of a lock lever driving unit.

FIG. 8 is a view showing the configuration of the lock lever driving unit.

FIG. 9 is a view showing a configuration of a carriage.

FIG. 10 is a view showing an engagement position.

FIG. 11 is a view showing a separation position.

FIG. 12 is a view showing a configuration of a lock lever position detection unit.

FIG. 13 is a view showing an engaged state of the lock lever.

FIG. 14 is a view showing a modification example of the lock lever.

FIG. 15 is a view showing a modification example of the lock lever.

FIG. 16 is a view showing a modification example of a claw portion.

FIG. 17 is a view showing a modification example of the lock lever.

FIG. 18 is a view showing a modification example of the lock lever.

FIG. 19 is a view showing a modification example of the lock lever.

FIG. 20 is a view showing a modification example of the lock lever driving unit.

FIG. 21 is an exploded view of the lock lever driving unit.

FIG. 22 is a view showing a configuration of the main part of the restriction mechanism.

FIG. 23 is a view showing a state where movement of a movable frame is restricted by the lock lever.

FIG. 24 is a view showing a state where the movable frame of which movement is restricted by the lock lever is released.

FIG. 25 is a view showing configurations of the lock lever, a rotational movement member, and the lock lever driving unit.

FIG. 26 is a view showing a modification example of the lock lever.

### DESCRIPTION OF THE PREFERRED EMBODIMENTS

Hereinafter, preferred embodiments of the present invention will be described in detail with reference to the attached drawings.

### First Embodiment

Here, a case where the present invention is applied to a focus lens unit of a camera lens will be described as an example. The focus lens unit is a lens unit used for focus adjustment in a camera lens. The focus lens unit has a configuration in which at least a part of lens groups is movable in an extending direction of an optical axis. Examples of the camera lens include not only a so-called interchangeable lens of a lens-interchangeable camera but also a lens that is integrally incorporated into a body of a camera. Examples of the camera include a digital camera (including a video camera), a silver halide camera, a TV camera, and a cine-camera. Examples of the digital camera include a digital camera mounted to an electronic apparatus such as a smartphone.

### [Focus Lens Unit]

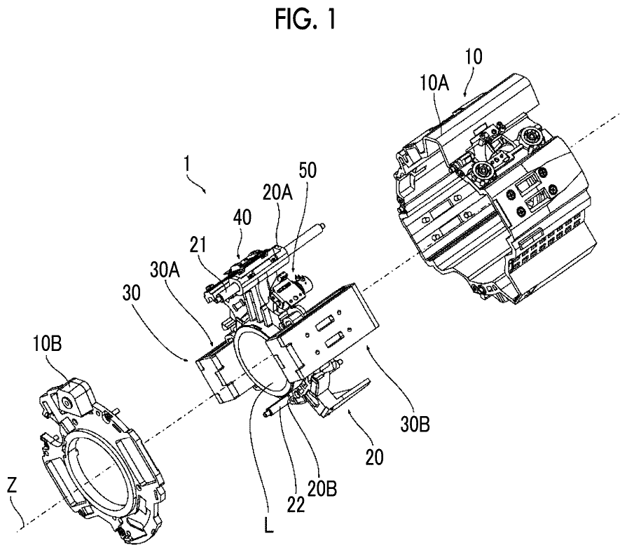

FIG. 1 is an exploded view of a focus lens unit.

As shown in the drawing, a focus lens unit 1 of the present embodiment includes a lens barrel 10, a movable frame 20 that moves in the lens barrel 10 in an extending direction of an optical axis Z, a movable frame driving unit 30 that drives the movable frame 20, a position detection unit 40 that detects the position of the movable frame 20, and a restriction mechanism 50 that restricts movement of the movable frame 20. In the present embodiment, the focus lens unit 1 is an example of a lens device.

### [Lens Barrel]

The lens barrel 10 is composed of a lens barrel body 10A of which a distal end side (an object side) is open and a front cover 10B mounted to a distal end portion of the lens barrel body 10A, the distal end portion being open. The front cover 10B is composed of a plate-shaped member that includes a circular opening portion provided at a central portion thereof and the front cover 10B is attachably and detachably attached to the distal end portion of the lens barrel body 10A by means of a screw.

### [Movable Frame]

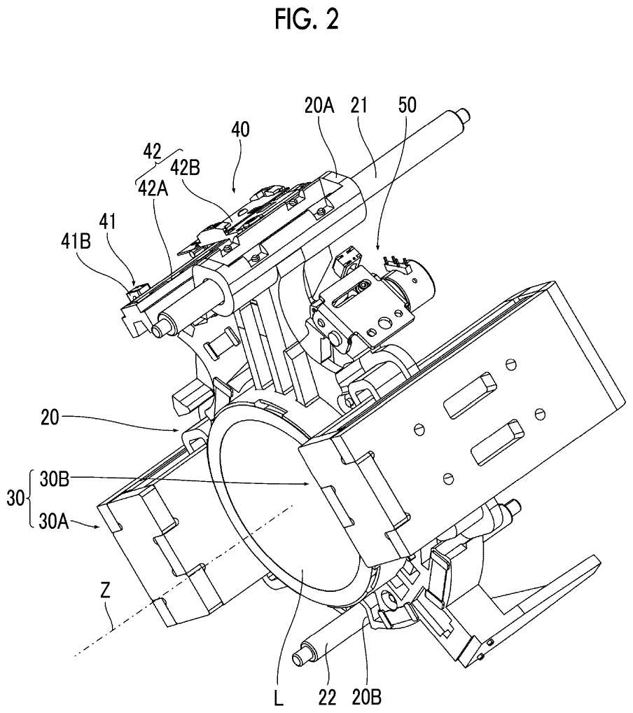

FIG. 2 is a view showing an internal structure of the lens barrel.

The movable frame 20 holds a lens group L. The lens group L is composed of at least one lens (optical element). The movable frame 20 is composed of a resin-molded product. For example, the movable frame 20 is composed of a resin-molded product formed of engineering plastics (thermoplastic resins) such as polycarbonate resin (PC) and polyacetal resin (POM).

The movable frame 20 is moved in the lens barrel 10 in the extending direction of the optical axis Z by being guided by a main shaft 21 and a sub-shaft 22 extending in the extending direction of the optical axis Z.

Both end portions of each of the main shaft 21 and the sub-shaft 22 are supported by support portions (not shown) provided at the lens barrel 10 and the main shaft 21 and the sub-shaft 22 are disposed in the extending direction of the optical axis Z.

The movable frame 20 includes a main guide portion 20A that is engaged with the main shaft 21 and a sub-guide portion 20B that is engaged with the sub-shaft 22.

The main guide portion 20A is a main guide portion for guidance of the movable frame 20. The main guide portion 20A has a tubular shape extending in an axial direction parallel to the optical axis Z.

The sub-guide portion 20B is a subordinate guide portion for guidance of the movable frame 20. That is, the sub-guide portion 20B is a guide portion that assists in guidance performed by the main guide portion 20A. A main function of the sub-guide portion 20B is to restrain the movable frame 20 from moving or rotating (rotating about the main shaft 21) in a plane orthogonal to the optical axis Z. The sub-guide portion 20B is composed of a recess portion to which the sub-shaft 22 can be fitted.

The movable frame 20 is supported to be movable in the lens barrel 10 in the extending direction of the optical axis Z with the main guide portion 20A slid along the main shaft 21 and the sub-guide portion 20B slid along the sub-shaft 22. In the present embodiment, the main shaft 21 is an example of a first shaft and a direction in which the main shaft 21 is disposed is an example of a first axial direction. In addition, the sub-shaft 22 is an example of a second shaft and a direction in which the sub-shaft 22 is disposed is an example of a second axial direction. In addition, the main guide portion 20A is an example of a first guide portion and the sub-guide portion 20B is an example of a second guide portion.

### [Movable Frame Driving Unit]

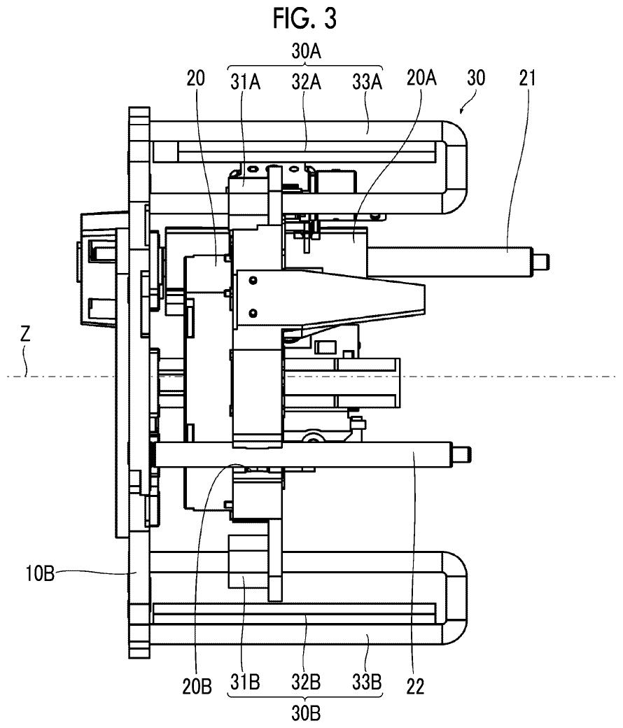

FIG. 3 is a perspective view showing the configuration of the movable frame driving unit.

The movable frame driving unit 30 is composed of a set of voice coil motors 30A and 30B. Each of the voice coil motors 30A and 30B is a type of linear motor and generates thrust in a linear direction.

The voice coil motors 30A and 30B include coils 31A and 31B, magnets 32A and 32B, and yokes 33A and 33B. In the present embodiment, the voice coil motors 30A and 30B are composed of so-called moving-coil type voice coil motors. Regarding the moving-coil type voice coil motors 30A and 30B, only the coils 31A and 31B move in a magnetic field generated by the magnets 32A and 32B and the yokes 33A and 33B in a case where a voltage is applied to the coils 31A and 31B. Therefore, the coils 31A and 31B are attached to the movable frame 20. The magnets 32A and 32B and the yokes 33A and 33B are configured as integrated components and are attached to the lens barrel 10.

Regarding the movable frame driving unit 30 configured as described above, the movable frame 20 moves in the extending direction of the optical axis Z in a case where a voltage is applied to the coils 31A and 31B. Accordingly, the lens group L moves in the extending direction of the optical axis Z. On the other hand, regarding the movable frame driving unit 30, a force that holds the movable frame 20 is lost in a case where the coils 31A and 31B enter a non-electrified state (for example, a state where the power is off). As a result, the movable frame 20 becomes able to move freely.

In the present embodiment, the movable frame driving unit 30 is an example of a first driving unit. In addition, the movable frame driving unit 30 is an example of a driving unit that allows the movable frame 20 to move freely in the case of a non-electrified state.

### [Position Detection Unit]

The position detection unit 40 detects the position of the movable frame 20. The position of the lens group L held by the movable frame 20 is detected since the position of the movable frame 20 is detected.

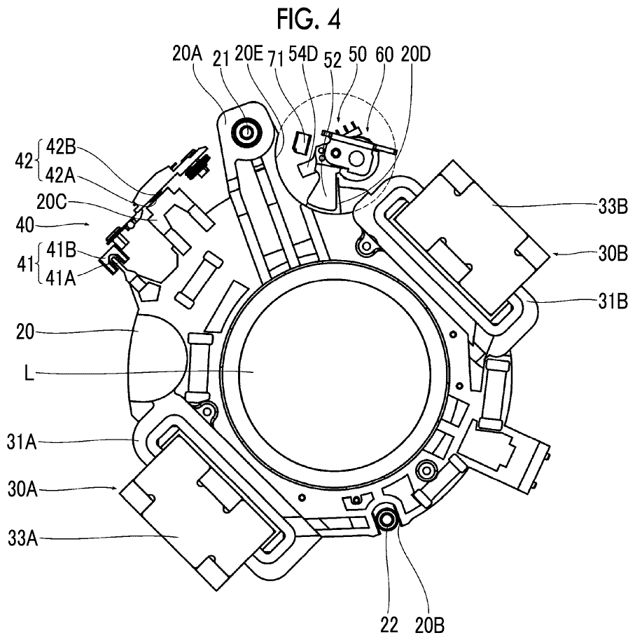

FIG. 4 is a view showing a configuration of the position detection unit.

The position detection unit 40 detects the position of the movable frame 20 with respect to a reference position (the position of an origin). Therefore, the position detection unit 40 includes a reference position detection unit 41 that detects that the movable frame 20 is positioned at the reference position and a movement amount detection unit 42 that detects the amount of movement (the amount of displacement) of the movable frame 20.

The reference position detection unit 41 is composed of a light blocking plate 41A and a photointerrupter 41B. The light blocking plate 41A is provided at the movable frame 20. Meanwhile, the photointerrupter 41B is provided at the lens barrel 10. In a case where the movable frame 20 is positioned at the reference position, the light blocking plate 41A blocks light to a light receiving portion (not shown) of the photointerrupter 41B. That is, light to be received by the light receiving portion is blocked. Accordingly, it is detected that the movable frame 20 is positioned at the reference position.

The movement amount detection unit 42 is composed of a magnetic scale 42A and a magneto resistive sensor (MR sensor) 42B that detects magnetic information (the N pole and the S pole) of the magnetic scale 42A.

The magnetic scale 42A has a rectangular sheet-like shape, and has a structure in which N poles and S poles are repeatedly magnetized at a constant pitch along a longitudinal direction (a so-called magnetization sheet). The magnetic scale 42A is attached to a magnetic scale attachment portion 20C provided at the movable frame 20 and is disposed in the extending direction of the optical axis Z.

The MR sensor 42B is attached to the lens barrel 10. The MR sensor 42B attached to the lens barrel 10 is disposed on a movement path of the magnetic scale 42A and is disposed to face the magnetic scale 42A. The MR sensor 42B reads the magnetic information of the magnetic scale 42A to detect the amount of movement (the amount of displacement) of the magnetic scale 42A. The amount of movement of the movable frame 20 is detected since the amount of movement of the magnetic scale 42A is detected. In addition, accordingly, the amount of movement of the lens group L held by the movable frame 20 is detected.

The position detection unit 40 configured as described above detects the position of the movable frame 20 as follows. First, the reference position detection unit 41 detects that the movable frame 20 is positioned at the reference position. Then, the movement amount detection unit 42 detects the amount of movement (the amount of displacement) of the movable frame 20. Accordingly, the amount of movement of the movable frame 20 with respect to the reference position can be detected. The position of the movable frame 20 with respect to the reference position is detected based on the detected amount of movement of the movable frame 20. In addition, the position of the lens group L with respect to the reference position is detected since the position of the movable frame 20 with respect to the reference position is detected.

### [Restriction Mechanism]

The restriction mechanism 50 restricts movement of the movable frame 20 at a predetermined lock position set within the movable range of the movable frame 20. That is, the restriction mechanism 50 locks the movable frame 20 not to move in the lens barrel 10.

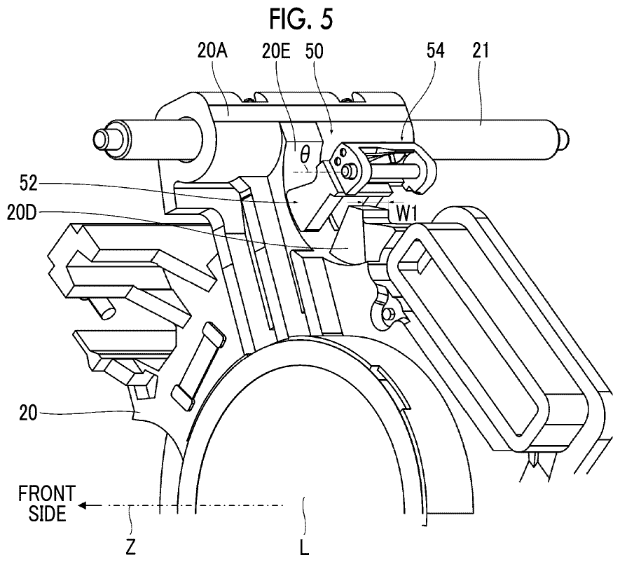

FIG. 5 is a view showing a configuration of a main part of the restriction mechanism.

The restriction mechanism 50 includes a lock lever 52 that rotationally moves around a rotational axis θ extending in the extending direction of the optical axis Z. The restriction mechanism 50 restricts movement of the movable frame 20 by causing the lock lever 52 to be engaged with a claw portion 20D provided at the movable frame 20. More specifically, the restriction mechanism 50 restricts the movement of the movable frame 20 by causing the lock lever 52 to clamp the claw portion 20D. The lock lever 52 is driven by a lock lever driving unit 60 to rotationally move between an engagement position and a separation position.

### [Lock Lever]

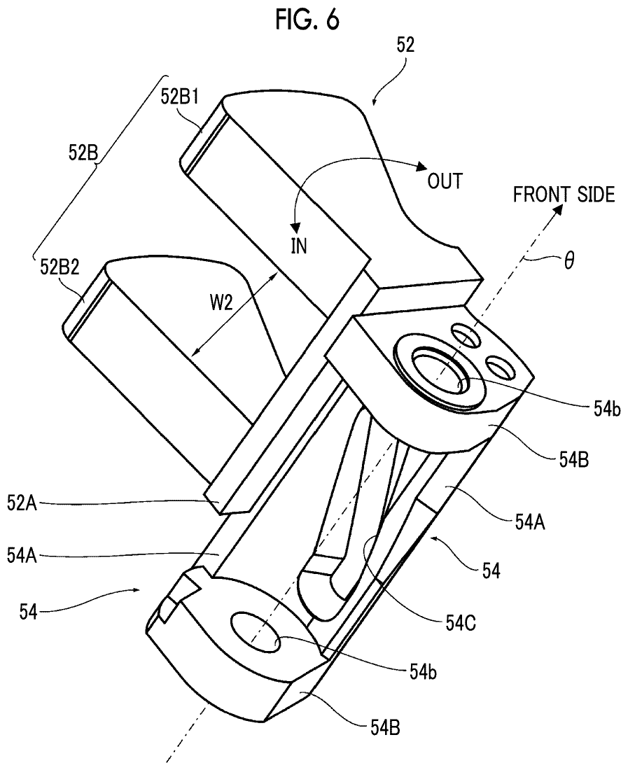

FIG. 6 is a view showing a configuration of a lock lever.

The lock lever 52 is composed of a base portion 52A and a clamping portion 52B. The base portion 52A has a rectangular flat plate-like shape. The clamping portion 52B is composed of a first clamping portion 52B1 and a second clamping portion 52B2. The first clamping portion 52B1 and the second clamping portion 52B2 have fan-like shapes and the first clamping portion 52B1 and the second clamping portion 52B2 are disposed on the base portion 52A with an interval W2 provided therebetween in the extending direction of the optical axis Z. An arc-shaped portion of a distal end of each of the first clamping portion 52B1 and the second clamping portion 52B2 constitutes a part of a circle around the rotational axis θ. That is, each of the first clamping portion 52B1 and the second clamping portion 52B2 has a shape including an arc around the rotational axis θ in a cross section (a cross section intersecting the optical axis Z) orthogonal to the optical axis Z.

The lock lever 52 has a recessed shape as a whole since the first clamping portion 52B1 and the second clamping portion 52B2 are disposed on the base portion 52A with the interval W2 provided therebetween. That is, the lock lever 52 has a recessed shape as a whole since a gap formed between the first clamping portion 52B1 and the second clamping portion 52B2 constitutes a recess portion.

The lock lever 52 is configured such that at least the first clamping portion 52B1 and the second clamping portion 52B2 are elastically deformable in the extending direction of the optical axis Z. That is, the lock lever 52 is configured such that the size of the interval between the first clamping portion 52B1 and the second clamping portion 52B2 can be increased or decreased. In the present embodiment, the lock lever 52 is formed of resin and is configured to be elastically deformable. For example, the lock lever 52 is composed of a resin-molded product formed of engineering plastics such as PC or POM. In the present embodiment, the lock lever 52 is an example of a first engagement portion. In addition, the first clamping portion 52B1 is an example of a first protruding portion, and the second clamping portion 52B2 is an example of a second protruding portion.

The lock lever 52 is integrally provided with a rotational movement member 54 that is rotationally movable around the rotational axis θ. The rotational movement member 54 is composed of a rotational movement member body 54A, a pair of bearing portions 54B provided at both end portions of the rotational movement member body 54A, and a light blocking plate 54D provided at one end portion of the rotational movement member body 54A.

The rotational movement member body 54A has a shape obtained by cutting off a part of a cylinder (the rotational movement member body 54A has an arc-like shape in a cross section orthogonal to the rotational axis θ). The base portion 52A of the lock lever 52 is integrally provided with the rotational movement member body 54A.

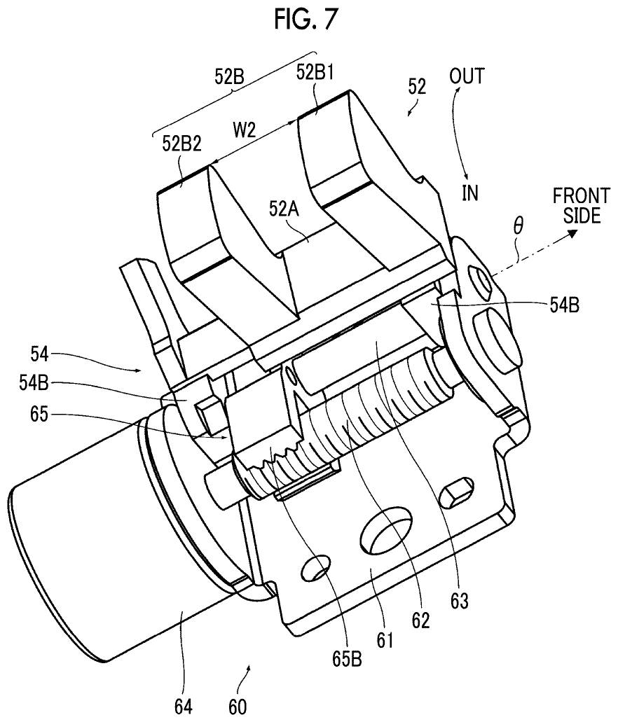

The pair of bearing portions 54B is provided at both end portions of the rotational movement member body 54A and each bearing portion 54B includes a hole 54b through which a guide shaft 63 (refer to FIG. 7) passes.

The light blocking plate 54D is used for detection of the rotational movement position of the rotational movement member 54. The light blocking plate 54D will be described later.

In a case where the rotational movement member 54 is rotationally moved around the rotational axis θ, the lock lever 52 configured as described above is integrally moved with the rotational movement member 54 to rotationally move around the rotational axis θ.

Note that, as described above, in the present embodiment, the lock lever 52 is formed of resin. Therefore, the rotational movement member 54 is also formed of resin. That is, in the present embodiment, an integrated component of the lock lever 52 and the rotational movement member 54 is composed of a resin-molded product.

### [Lock Lever Driving Unit]

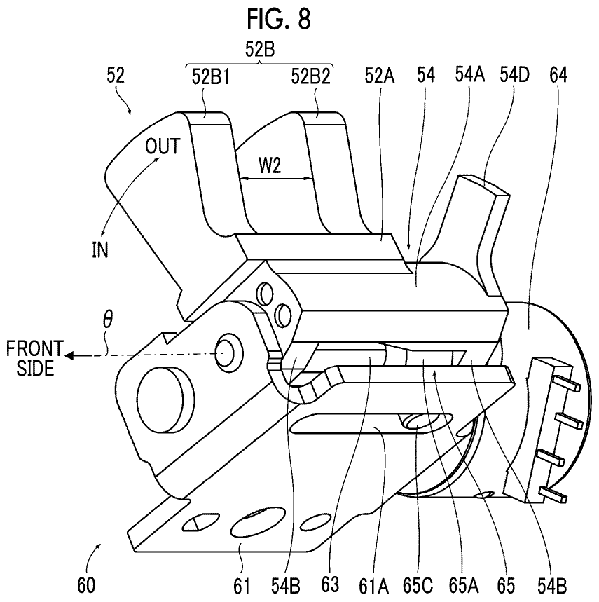

FIGS. 7 and 8 are views showing a configuration of the lock lever driving unit.

The lock lever driving unit 60 rotationally moves the rotational movement member 54 so that the lock lever 52 rotationally moves. In the present embodiment, the rotational movement member 54 is rotationally moved by means of a cam mechanism. In the present embodiment, the lock lever driving unit 60 is an example of a second driving unit.

As shown in FIGS. 7 and 8, the lock lever driving unit 60 is composed of a base frame 61, a lead screw 62 and the guide shaft 63 provided at the base frame 61, a lock lever driving motor 64, a carriage 65 that slides along the guide shaft 63, a rectilinear guide pin 65C and a cam pin 65D provided at the carriage 65, a rectilinear guide groove 61A provided at the base frame 61, a cam groove 54C provided at the rotational movement member 54, and the like.

The base frame 61 is composed of a sheet metal member that is bent and molded into a predetermined shape. The base frame 61 is provided to be fixed to the lens barrel 10 via screws (not shown).

The lead screw 62 and the guide shaft 63 are both disposed in the extending direction of the optical axis Z. Therefore, the lead screw 62 and the guide shaft 63 are disposed to be parallel to each other. The lead screw 62 is provided at the base frame 61 such that both end portions thereof are supported to be rotationally movable. Meanwhile, the guide shaft 63 is provided at the base frame 61 such that both end portions thereof are fixed. The guide shaft 63 is caused to pass through the holes 54b of the bearing portions 54B of both ends of the rotational movement member 54, so that the rotational movement member 54 is supported by the guide shaft 63 to be rotationally movable. Therefore, an axis of the guide shaft 63 constitutes the rotational axis θ. The lead screw 62 is an example of a screw member.

The lock lever driving motor 64 is mounted to the base frame 61. The lock lever driving motor 64 rotationally drives the lead screw 62. In the present embodiment, the lock lever driving motor 64 is an example of an actuator.

The carriage 65 slides along the guide shaft 63. In the present embodiment, the carriage 65 is an example of a sliding member.

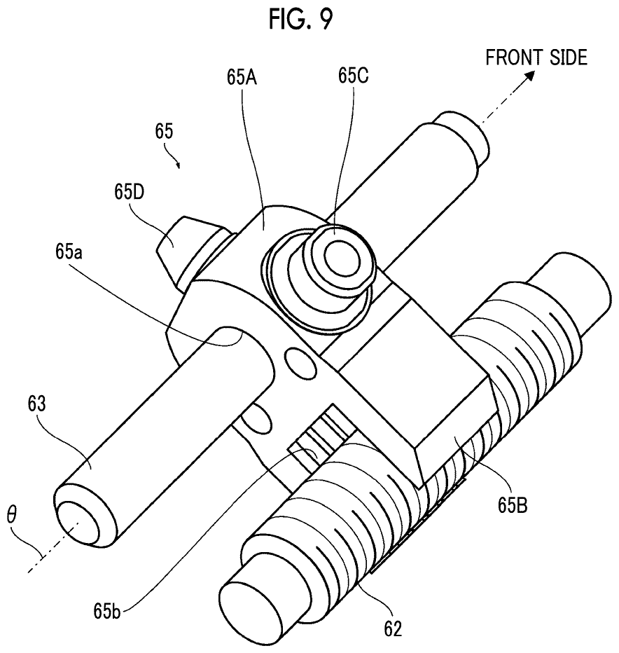

FIG. 9 is a view showing a configuration of the carriage. As shown in FIG. 9, the carriage 65 has a configuration in which a nut portion 65B, the rectilinear guide pin 65C, and the cam pin 65D are integrally provided with a carriage body 65A.

The carriage body 65A includes a guide hole 65a through which the guide shaft 63 passes. The carriage 65 slides along the guide shaft 63 with the guide shaft 63 passing through the guide hole 65a.

The nut portion 65B is integrally provided with the carriage body 65A, as a U-shaped groove portion of which an interior wall portion is composed of a female screw 65b. The nut portion 65B of the carriage 65 is screw-bonded to the lead screw 62. Accordingly, in a case where the lead screw 62 is rotationally moved, the carriage 65 is moved along the guide shaft 63. In the present embodiment, the lead screw 62 is an example of a screw portion.

The rectilinear guide pin 65C is composed of a columnar pin. As shown in FIG. 8, the rectilinear guide pin 65C is fitted to the rectilinear guide groove 61A provided at the base frame 61. The rectilinear guide groove 61A is composed of a linear groove and is provided to be parallel with the guide shaft 63. Accordingly, the rectilinear guide groove 61A is disposed in the extending direction of the optical axis Z. The carriage 65 is restricted from rotationally moving around the guide shaft (rotationally moving around the rotational axis) since the rectilinear guide pin 65C is fitted to the rectilinear guide groove 61A.

The cam pin 65D is composed of a pin of which a distal end has a shape like a circular truncated cone. The cam pin 65D is fitted to the cam groove 54C provided at the rotational movement member 54. As shown in FIG. 6, the cam groove 54C is provided in an inner peripheral surface of the rotational movement member body 54A. The cam groove 54C has a shape that causes the rotational movement member 54 to rotationally move in a predetermined angular range in a case where the cam pin 65D reciprocates in a predetermined distance range.

In a case where the lock lever driving motor 64 of the lock lever driving unit 60 configured as described above is driven and the lead screw 62 is rotationally moved, the carriage 65 linearly moves along the guide shaft 63 due to the action of the screw. That is, a rotational motion caused by the lock lever driving motor 64 is converted into a linear motion of the carriage 65. Then, in a case where the carriage 65 is linearly moved, the rotational movement member 54 is rotationally moved around the rotational axis θ due to the action of the cam pin 65D provided at the carriage 65 and the cam groove 54C provided at the rotational movement member 54. That is, a linear motion of the carriage 65 is converted into a rotational motion of the rotational movement member 54. As a result, the lock lever 52 that is integrally provided with the rotational movement member 54 is rotationally moved around the rotational axis θ.

The lock lever driving unit 60 having such a configuration can suppress rotational movement of the lock lever 52 even in a case where the lock lever driving motor 64 enters a non-electrified state with the power being off or the like, for example. Accordingly, it is possible to maintain the state of the lock lever 52 even in a non-electrified state.

### [Lock Lever Position Detection Unit]

As described above, the lock lever 52 is driven by the lock lever driving unit 60 to rotationally move between the engagement position and the separation position.

FIG. 10 is a view showing the engagement position. The “engagement position” is a position where the lock lever 52 is engaged with the claw portion 20D provided at the movable frame 20. Therefore, the engagement position is a position where the lock lever 52 restricts movement of the movable frame 20. As will be described later, movement of the movable frame 20 is restricted in a case where the movable frame driving unit 30 is in a non-electrified state with the power being off or the like. Therefore, the engagement position is also a position in the case of a non-electrified state of the movable frame driving unit 30. The engagement position is an example of a second position.

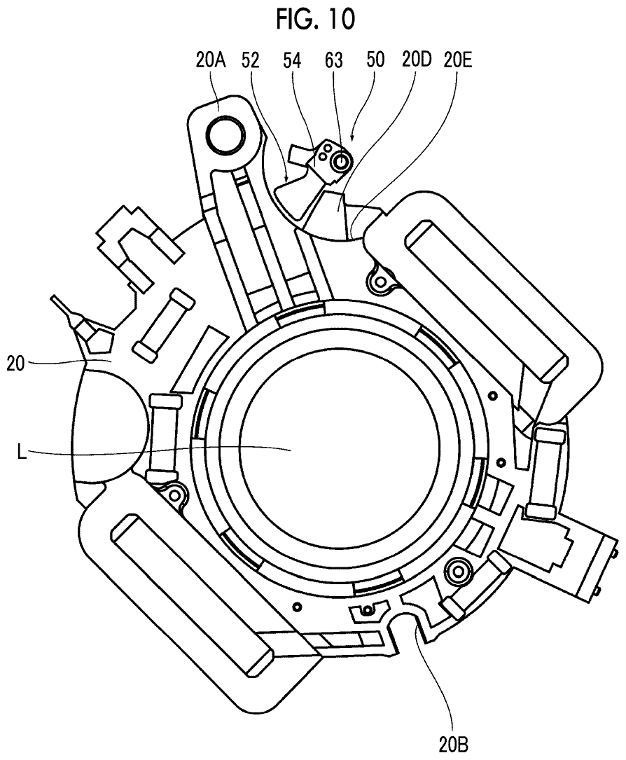

FIG. 11 is a view showing the separation position. The “separation position” is a position at which the lock lever 52 is separated from the claw portion 20D (a position at which the lock lever 52 is disengaged from the claw portion 20D). Therefore, the separation position is a position at which the movable frame 20 restricted from moving is released. As will be described later, the movable frame 20 restricted from moving is released in a case where the movable frame driving unit 30 is electrified. In other words, the movable frame 20 is allowed to move in a case where the movable frame driving unit 30 is electrified. Therefore, the separation position is also a position in the case of an electrified state of the movable frame driving unit 30. The separation position is an example of a first position.

In the lens barrel 10, a lock lever position detection unit 70 that detects that the lock lever 52 is positioned at the separation position is provided.

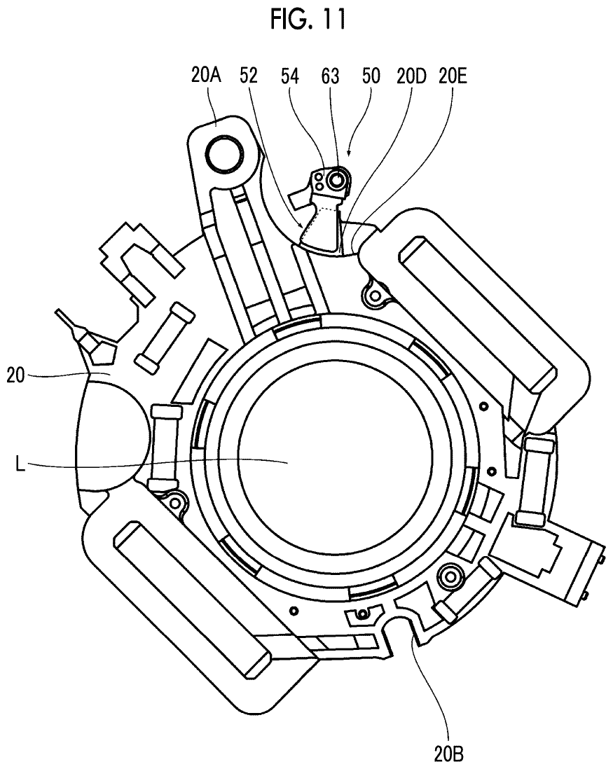

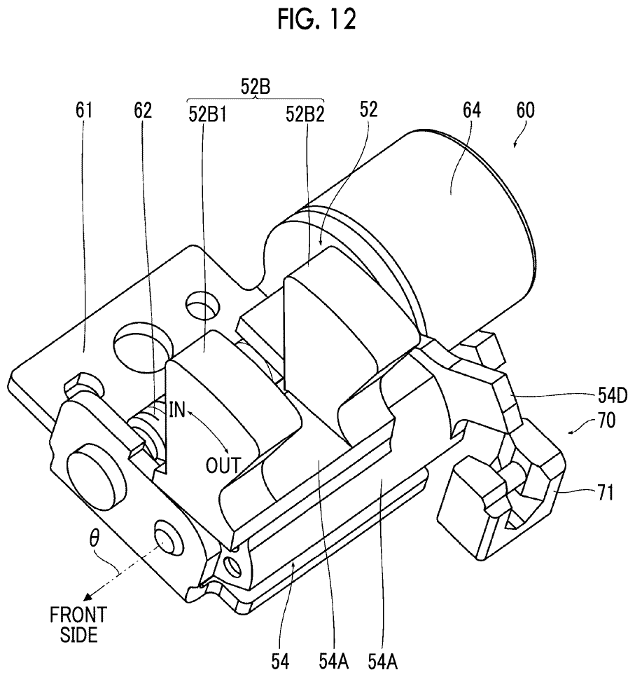

FIG. 12 is a view showing a configuration of the lock lever position detection unit.

The lock lever position detection unit 70 is composed of the light blocking plate 54D and a photointerrupter 71. The light blocking plate 54D is provided at the rotational movement member 54. More specifically, the light blocking plate 54D is provided at one end portion of the rotational movement member body 54A to be orthogonal to the rotational axis θ. Meanwhile, the photointerrupter 71 is provided at the lens barrel 10. In a case where the lock lever 52 is positioned at the separation position, the light blocking plate 54D blocks light to a light receiving portion (not shown) of the photointerrupter 71. That is, light to be received by the light receiving portion is blocked. Accordingly, it is detected that the lock lever 52 is positioned at the separation position.

### [Claw Portion]

As described above, the restriction mechanism 50 of the present embodiment restricts movement of the movable frame 20 by causing the lock lever 52 to be engaged with the claw portion 20D provided at the movable frame 20. In the present embodiment, the claw portion 20D is an example of a second engagement portion. In addition, the claw portion 20D is also an example of a third protruding portion.

As shown in FIG. 5, the claw portion 20D is composed of a plate-shaped protruding portion having a fan-like shape in a cross section orthogonal to the optical axis Z and is disposed to be orthogonal to the optical axis Z. In the extending direction of the optical axis Z, the claw portion 20D has a width enough to be clamped by the lock lever 52. Particularly, in the present embodiment, the claw portion 20D has a width W1 enough to be press-fitted between the first clamping portion 52B1 and the second clamping portion 52B2 of the lock lever 52. Therefore, in the present embodiment, the claw portion 20D has the width W1 larger than the interval W2 between the first clamping portion 52B1 and the second clamping portion 52B2 (W2<W1).

The claw portion 20D is provided at a predetermined position on an outer peripheral portion of the movable frame 20. It is preferable that this position is a position relatively closer to the main guide portion 20A than to the sub-guide portion 20B. As described above, the main guide portion 20A is a main guide portion for guidance of the movable frame 20. Since the claw portion 20D is provided at the position relatively closer to the main guide portion 20A than to the sub-guide portion 20B, the lock lever 52 can be engaged in a more stable state.

In the present embodiment, as shown in FIG. 5, an arc-shaped cutout portion 20E is provided adjacent to the main guide portion 20A, and the claw portion 20D is provided in the cutout portion 20E. As shown in FIG. 4, the cutout portion 20E is configured by cutting off an outer peripheral portion of the movable frame 20 into an arc shape. An arc constituting the cutout portion 20E constitutes a part of a circle around the rotational axis θ of the lock lever 52 in a cross section orthogonal to the optical axis Z (refer to FIG. 4). That is, the cutout portion 20E has a shape including an arc around the rotational axis θ in a cross section orthogonal to the optical axis Z. Similarly, the claw portion 20D also has a shape including an arc around the rotational axis θ in a cross section orthogonal to the optical axis Z.

Since the cutout portion 20E is provided at an outer periphery of the movable frame 20 and the claw portion 20D is provided in the cutout portion 20E in this manner, it is possible to realize reduction in size of the entire movable frame 20 while ensuring the stiffness of the movable frame 20.

### [Lock Position of Movable Frame]

As described above, movement of the movable frame 20 is restricted at the predetermined lock position set within the movable range of the movable frame 20. For example, in the present embodiment, the lock position is set at a position of an end portion on the object side (the front side).

The lock lever 52 is provided at a position corresponding to the claw portion 20D of the movable frame 20 positioned at the lock position. Specifically, the lock lever 52 is provided at a position at which the lock lever 52 is engaged with the claw portion 20D of the movable frame 20 positioned at the lock position in a case where the lock lever 52 is rotationally moved around the rotational axis θ. Therefore, in a case where the movable frame 20 is positioned at the lock position, the claw portion 20D is positioned between the first clamping portion 52B1 and the second clamping portion 52B2 of the lock lever 52. Accordingly, in a case where the lock lever 52 is rotationally moved around the rotational axis θ, the claw portion 20D is inserted into a space between the first clamping portion 52B1 and the second clamping portion 52B2.

### [Action of Focus Lens Unit]

In the focus lens unit 1 of the present embodiment configured as described above, the movable frame 20 moves in the extending direction of the optical axis Z in a case where the movable frame driving unit 30 is driven. The position of the movable frame 20 is detected by the position detection unit 40.

In a case where the movable frame 20 moves in the extending direction of the optical axis Z, the lens group L held by the movable frame 20 moves in the extending direction of the optical axis Z. Accordingly, there is a change in focal position.

The movable frame driving unit 30 is composed of the voice coil motors 30A and 30B, and the movable frame 20 moves in the extending direction of the optical axis Z in a case where a voltage is applied to the coils 31A and 31B. Regarding the movable frame driving unit 30 composed of the voice coil motors 30A and 30B as described above, a force that holds the movable frame 20 is lost in a case where the coils 31A and 31B enter a non-electrified state with the power being off or the like, for example. As a result, the movable frame 20 becomes able to move freely.

Therefore, in a case where the movable frame driving unit 30 is in a non-electrified state with the power being off or the like, movement of the movable frame 20 is restricted by means of the restriction mechanism 50. Hereinafter, a method of restricting movement of the movable frame 20 will be described.

In a case where the movable frame driving unit 30 is to be brought into a non-electrified state with the power being off or the like, first, the movable frame 20 is moved to the lock position. As described above, the position of the movable frame 20 is detected by the position detection unit 40.

In a case where the movable frame 20 is positioned at the lock position, the claw portion 20D provided at the movable frame 20 is positioned at an installation position of the lock lever 52. More specifically, the claw portion 20D is positioned between the first clamping portion 52B1 and the second clamping portion 52B2 constituting the lock lever 52.

After the movable frame 20 is positioned at the lock position, the lock lever driving unit 60 is driven such that the lock lever 52 is rotationally moved from the separation position (refer to FIG. 10) to the engagement position (refer to FIG. 11). Accordingly, the lock lever 52 is engaged with the claw portion 20D provided at the movable frame 20, so that movement of the movable frame 20 is restricted.

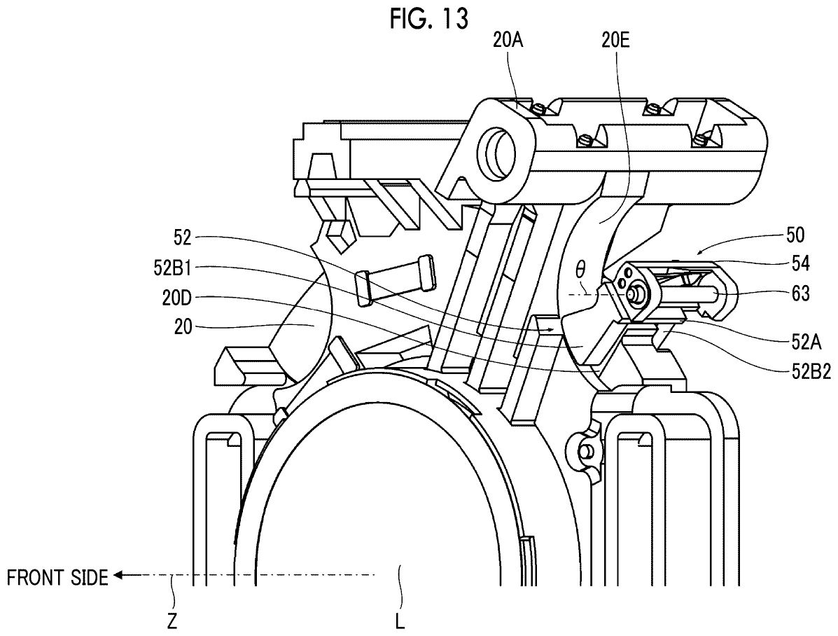

FIG. 13 is a view showing an engaged state of the lock lever.

As shown in the drawing, in a case where the lock lever 52 is engaged with the claw portion 20D, the claw portion 20D is clamped by the clamping portion 52B of the lock lever 52. More specifically, the claw portion 20D is clamped by the first clamping portion 52B1 and the second clamping portion 52B2 of the clamping portion 52B. Accordingly, movement of the movable frame 20 is restricted.

In a case where the lock lever 52 is to be engaged with the claw portion 20D, the claw portion 20D is inserted into the space between the first clamping portion 52B1 and the second clamping portion 52B2 while elastically deforming the first clamping portion 52B1 and the second clamping portion 52B2 of the lock lever 52. That is, the claw portion 20D is press-fitted between the first clamping portion 52B1 and the second clamping portion 52B2. Accordingly, the claw portion 20D can be clamped by the first clamping portion 52B1 and the second clamping portion 52B2 without a gap. That is, the claw portion 20D can be clamped in a state where there is no clearance between the first clamping portion 52B1 and the second clamping portion 52B2. Accordingly, movement of the movable frame 20 can be reliably restricted. In addition, accordingly, generation of an impact or an impact sound caused by free movement of the movable frame 20 can be suppressed.

In a case where the movable frame 20 restricted from moving is to be released, the movable frame 20 is released as follows. That is, the lock lever driving unit 60 is driven such that the lock lever 52 is rotationally moved from the engagement position (refer to FIG. 11) to the separation position (refer to FIG. 10). Accordingly, the lock lever 52 is separated from the claw portion 20D. In this case, the lock lever 52 is separated from the claw portion 20D with the first clamping portion 52B1 and the second clamping portion 52B2 being elastically deformed. Since the lock lever 52 is separated from the claw portion 20D, the lock lever 52 and the claw portion 20D are disengaged from each other. Accordingly, the movable frame 20 restricted by the lock lever 52 from moving is released and the movable frame 20 becomes able to move.

As described above, according to the focus lens unit 1 of the present embodiment, it is possible to restrict the movement of the movable frame 20 by causing the lock lever 52 to clamp the claw portion 20D without a gap in a case where movement of the movable frame 20 is to be restricted. Accordingly, an impact or an impact sound caused by free movement of the movable frame 20 can be effectively suppressed.

### Modification Examples

### [Shape of Lock Lever]

### First Modification Example of Shape of Lock Lever

In the present embodiment, each of the first clamping portion 52B1 and the second clamping portion 52B2 constituting the lock lever 52 have fan-like shapes. However, the shapes of the first clamping portion 52B1 and the second clamping portion 52B2 are not limited thereto. For example, the first clamping portion 52B1 and the second clamping portion 52B2 can be configured in rectangular plate-like shapes. The same applies to the claw portion 20D.

Meanwhile, in a case where each of the first clamping portion 52B1, the second clamping portion 52B2, and the claw portion 20D is formed in a fan-like shape (particularly, a shape including an arc around the rotational axis θ) as in the present embodiment, a large area of engagement can be secured. Accordingly, engagement can be made more reliable. In addition, improvement in impact resistance can also be achieved. That is, since pressure applied to each member can be reduced, the improvement in impact resistance can also be achieved. Therefore, for example, it is possible to achieve improvement in resistance against an impact received in the case of a fall or the like.

### Second Modification Example of Shape of Lock Lever

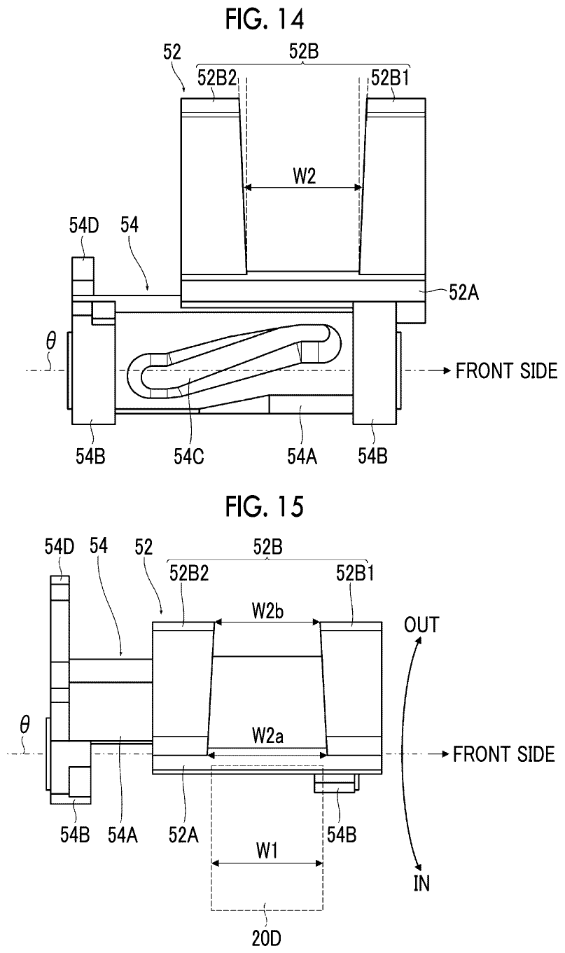

FIG. 14 is a view showing a modification example of the lock lever.

As shown in the drawing, each of the first clamping portion 52B1 and the second clamping portion 52B2 of the lock lever 52 in the present example has a tapered wedge-like shape. That is, each of the first clamping portion 52B1 and the second clamping portion 52B2 has a shape of which the width in the extending direction of the optical axis Z becomes smaller toward a distal end (a trapezoidal or tapered cross-sectional shape). More specifically, each of the first clamping portion 52B1 and the second clamping portion 52B2 has a shape of which the width in the extending direction of the optical axis Z decreases from the rotational axis θ toward an outer side.

Since the width in the extending direction of the optical axis Z becomes smaller toward the distal end in this manner, a spring constant in the case of engagement between the first clamping portion 52B1, the second clamping portion 52B2, and the claw portion 20D can be reduced. Accordingly, press-fitting can be realized without an increase in torque of an actuator (the lock lever driving motor 64). Therefore, a small actuator can be adopted. In addition, in a case where a so-called draft angle is provided, it is possible to easily manufacture the lock lever 52 in a case where the lock lever 52 is composed of a resin-molded product.

### Third Modification Example of Shape of Lock Lever

FIG. 15 is a view showing a modification example of the lock lever.

The lock lever 52 shown in the drawing is configured such that an interval between the first clamping portion 52B1 and the second clamping portion 52B2 becomes larger toward an engagement direction IN. More specifically, the lock lever 52 is configured such that surfaces (engagement surfaces) of the first clamping portion 52B1 and the second clamping portion 52B2 that face each other are inclined and thus the interval becomes larger from a separation direction OUT toward the engagement direction IN. That is, a recess portion composed of the first clamping portion 52B1 and the second clamping portion 52B2 is composed of a tapered space of which the width increases toward the engagement direction IN.

Here, the “engagement direction IN” refers to a direction in which the lock lever 52 rotationally moves in a case where the lock lever 52 is to be engaged with the claw portion 20D. The engagement direction IN is synonymous with a press-fitting direction. Meanwhile, the “separation direction OUT” refers to a direction in which the lock lever 52 rotationally moves in a case where the lock lever 52 is to be separated from the claw portion 20D. The separation direction OUT is synonymous with a release direction.

Regarding the interval between the first clamping portion 52B1 and the second clamping portion 52B2, an interval W2a at an end portion in the engagement direction IN is the largest and an interval W2b at an end portion in the separation direction OUT is the smallest. In addition, the interval W2a at the end portion in the engagement direction IN is larger than the width W1 of the claw portion 20D (W1<W2a) and the interval W2b at the end portion in the separation direction OUT is smaller than the width W1 of the claw portion 20D (W2b<W1).

According to the above-described configuration, interference between the lock lever 52 and the claw portion 20D can be suppressed and the lock lever 52 can be smoothly engaged with the claw portion 20D. That is, the claw portion 20D can be smoothly press-fitted to the recess portion of the lock lever 52.

Note that in a case where the claw portion 20D is to be inserted up to an end portion of the lock lever 52 in the separation direction OUT, the interval W2b at the end portion in the separation direction OUT may be set to be equal to the width W1 of the claw portion 20D (W2b=W1). In this case, the claw portion 20D can be held without a gap. In a case where the interval W2b at the end portion in the separation direction OUT is smaller than the width W1 of the claw portion 20D, the claw portion 20D can be held more reliably.

The shape of the recess portion of the lock lever 52 is a tapered shape in the present modification example and it is possible to achieve the same effect by making the shape of the claw portion 20D tapered.

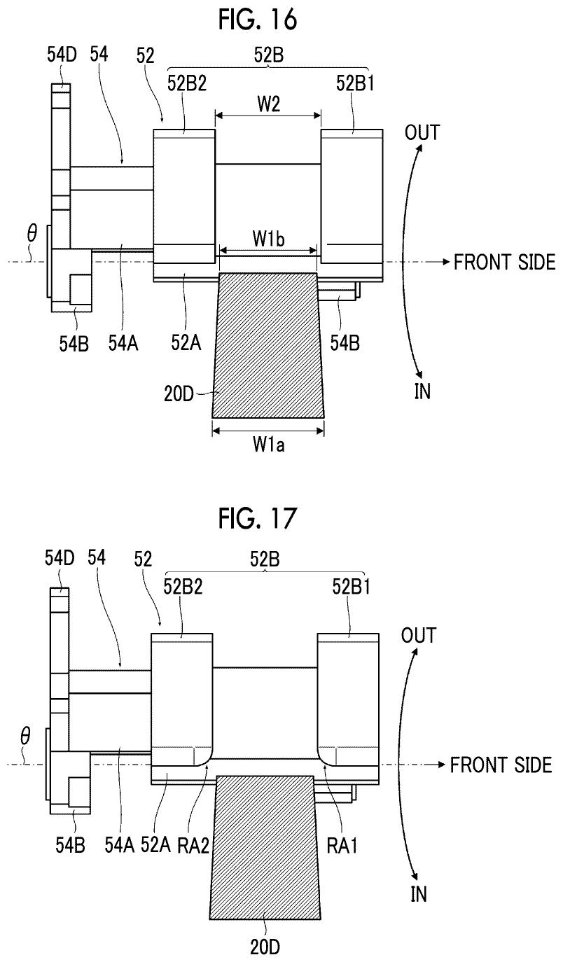

FIG. 16 is a view showing a modification example of the claw portion.

As shown in the drawing, the claw portion 20D of the present example has a shape of which the width in the extending direction of the optical axis Z decreases from the engagement direction IN of the lock lever 52 toward the separation direction OUT. Specifically, a width W1a of an end portion of the claw portion 20D in the engagement direction IN is the largest and a width W1b of an end portion of the claw portion 20D in the separation direction OUT is the smallest. In addition, the width W1a of the end portion in the engagement direction IN is larger than the interval (width) (an interval between the first clamping portion 52B1 and the second clamping portion 52B2) W2 of the recess portion of the lock lever 52 (W2<W1a) and the width W1b of the end portion in the separation direction OUT is smaller than the interval (width) W2 of the recess portion of the lock lever 52 (W1b<W2).

According to the present configuration, interference between the lock lever 52 and the claw portion 20D can be suppressed and the lock lever 52 can be smoothly engaged with the claw portion 20D.

In examples shown in FIGS. 15 and 16, only one of the recess portion of the lock lever 52 or the claw portion 20D has a tapered shape. However, both of the recess portion of the lock lever 52 and the claw portion 20D can have tapered shapes.

In a case where the recess portion of the lock lever 52 and/or the claw portion 20D has a tapered shape as in the present modification example, it is preferable that a biasing mechanism or a biasing member that biases the lock lever 52 in the engagement direction IN is provided. In this case, the claw portion 20D can be more reliably clamped by the lock lever 52. That is, the claw portion 20D can be more reliably clamped without wobbling. The biasing mechanism will be described later.

### Fourth Modification Example of Shape of Lock Lever

FIG. 17 is a view showing a modification example of the lock lever.

As shown in the drawing, in the case of the lock lever 52 of the present example, chamfered portions RA1 and RA2 are provided at edge portions of surfaces of the first clamping portion 52B1 and the second clamping portion 52B2 that face each other, the edge portions being on one side. Specifically, the chamfered portions RA1 and RA2 are provided at edge portions of surfaces facing each other, the edge portions being on the engagement direction IN side. That is, the chamfered portions RA1 and RA2 are provided at edge portions of distal end portions in the engagement direction IN.

Portions at which the chamfered portions RA1 and RA2 are provided are corner portions that come into contact with the claw portion 20D in a case where the lock lever 52 is engaged with the claw portion 20D. The chamfered portions RA1 and RA2 are provided at the first clamping portion 52B1 and the second clamping portion 52B2 by chamfering the corner portions (R-chamfering in the example shown in FIG. 17).

In a case where the corner portions that come into contact with the claw portion 20D are composed of the chamfered portions RA1 and RA2 in this manner, the corner portions can be prevented from being crushed. In addition, a stable amount of press-fitting force is applied in this case.

In the example shown in FIG. 17, the chamfered portions RA1 and RA2 are formed through R-chamfering. However, the chamfered portions RA1 and RA2 may be formed through so-called C-chamfering.

In addition, a method of providing the chamfered portions RA1 and RA2 is not particularly limited. Particularly, in a case where the lock lever 52 is formed of a resin-molded product, a configuration in which the chamfered portions RA1 and RA2 are provided at the time of molding may be adopted or a configuration in which the chamfered portions RA1 and RA2 are provided through a process of cutting the corner portions after resin molding or the like may be adopted.

### Fifth Modification Example of Shape of Lock Lever

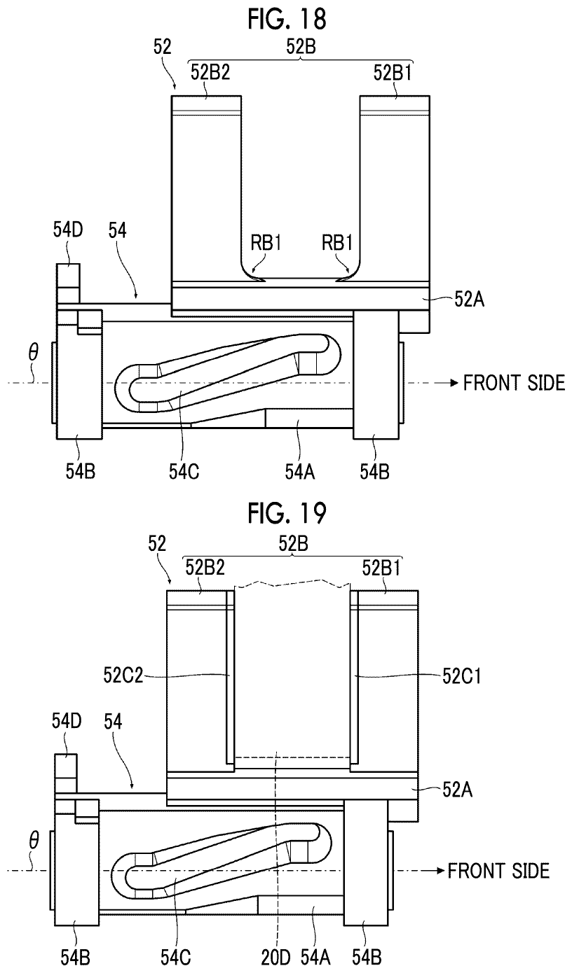

FIG. 18 is a view showing a modification example of the lock lever.

As shown in the drawing, in the case of the lock lever 52 of the present example, chamfered portions RB1 and RB2 are provided at root portions of the first clamping portion 52B1 and the second clamping portion 52B2. Specifically, the chamfered portions RB1 and RB2 are provided at boundary portions with respect to the base portion 52A. The boundary portions with respect to the base portion 52A are end portions of the first clamping portion 52B1 and the second clamping portion 52B2 that are on the rotational movement member 54 side.

Since the chamfered portions RB1 and RB2 are provided at the root portions of the first clamping portion 52B1 and the second clamping portion 52B2 in this manner, concentration of stress applied to the root portions can be suppressed and deformation can be suppressed. In addition, a stable amount of press-fitting force is applied in this case.

### Sixth Modification Example of Shape of Lock Lever

FIG. 19 is a view showing a modification example of the lock lever.

As shown in the drawing, in the case of the lock lever 52 of the present example, pads 52C1 and 52C2 (for example, rubber pads) composed of elastic bodies are provided on surfaces (engagement surfaces) of the first clamping portion 52B1 and the second clamping portion 52B2 that face each other. The claw portion 20D comes into contact with the pads 52C1 and 52C2 and is clamped by the first clamping portion 52B1 and the second clamping portion 52B2 of the lock lever 52. In the present example, the pads 52C1 and 52C2 are examples of elastic members.

Since the pads 52C1 and 52C2 composed of elastic bodies are provided on the engagement surfaces of the first clamping portion 52B1 and the second clamping portion 52B2 in this manner, it is possible to clamp the claw portion 20D while using elastic deformation of the pads 52C1 and 52C2.

Note that in a case where elastic members are provided on the engagement surfaces of the first clamping portion 52B1 and the second clamping portion 52B2 as in the present example, a portion of the lock lever 52 other than the elastic members can be composed of a rigid body. That is, a configuration other than the elastic members can be composed of a rigid body.

In addition, the elastic member may be provided only on one side. For example, a configuration in which the pad 52C1 is provided only on the first clamping portion 52B1 side may also be adopted.

### [Other Modification Example of Shape of Lock Lever]

The above-described modification examples can be used in combination as appropriate.

### [Modification Example of Lock Lever Driving Unit]

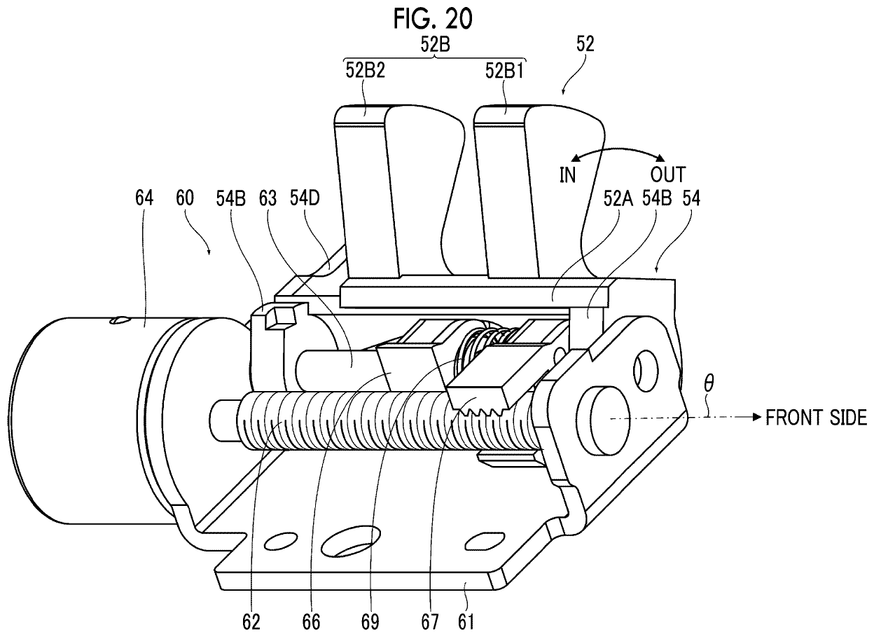

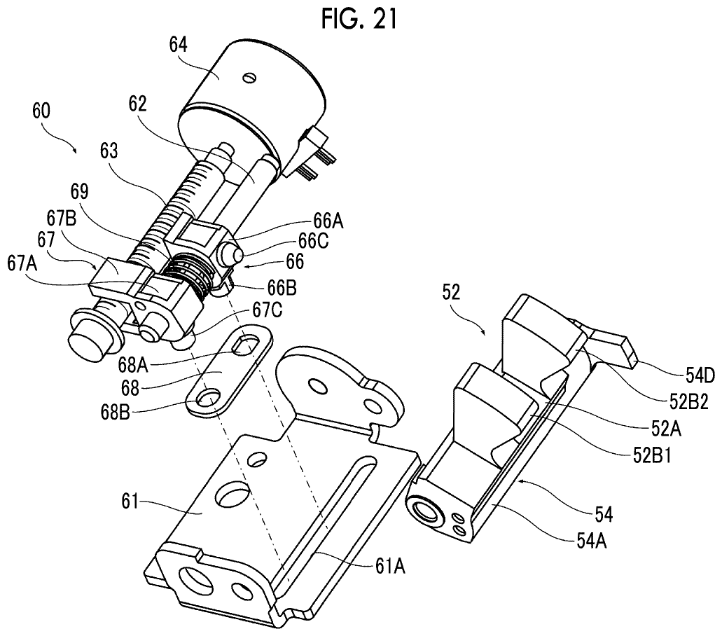

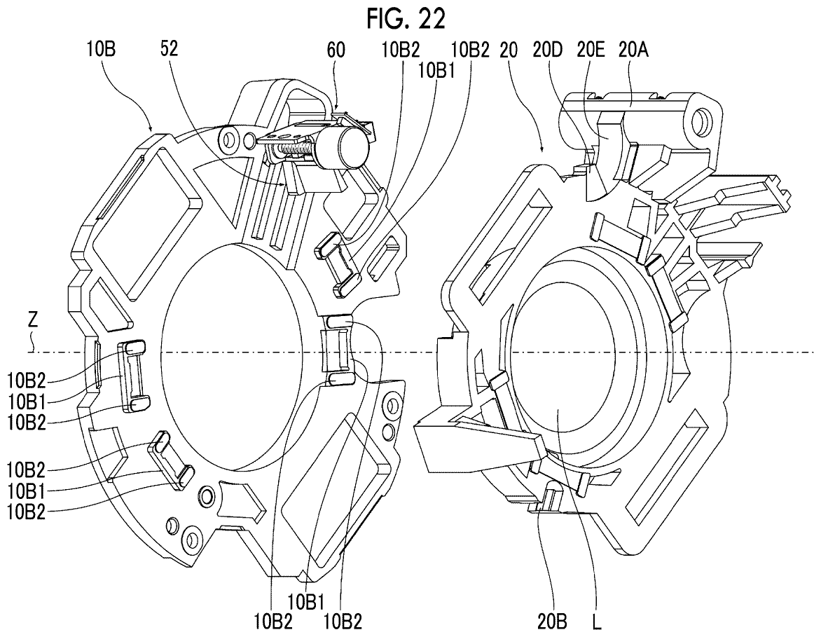

FIG. 20 is a view showing a modification example of the lock lever driving unit. FIG. 21 is an exploded view of the lock lever driving unit shown in FIG. 20.

The lock lever driving unit 60 of the present example includes a mechanism (a biasing mechanism) that biases the lock lever 52 in the engagement direction IN.

As shown in FIGS. 20 and 21, the lock lever driving unit 60 in the present example is composed of the base frame 61, the lead screw 62 and the guide shaft 63 provided at the base frame 61, the lock lever driving motor 64, a first carriage 66 and a second carriage 67 that slide along the guide shaft 63, a bridge member 68 that connects the first carriage 66 and the second carriage 67 to each other, a compression spring 69 that relatively biases the first carriage 66 with respect to the second carriage 67, a first rectilinear guide pin 66B and a cam pin 66C provided at the first carriage 66, a nut portion 67B and a second rectilinear guide pin 67C provided at the second carriage 67, the rectilinear guide groove 61A provided at the base frame 61, the cam groove 54C provided at the rotational movement member 54, and the like.

The configurations of the base frame 61, the lead screw 62, the guide shaft 63, and the lock lever driving motor 64 are the same as those in the above-described embodiment.

The first carriage 66 has a configuration in which the first rectilinear guide pin 66B and the cam pin 66C are integrally provided with a first carriage body 66A. The first carriage 66 is an example of a first sliding member.

The first carriage body 66A includes a guide hole 66a through which the guide shaft 63 passes. The first carriage 66 slides along the guide shaft 63 with the guide shaft 63 passing through the guide hole 66a.

The first rectilinear guide pin 66B is composed of a columnar pin. The first rectilinear guide pin 66B is fitted to the rectilinear guide groove 61A provided at the base frame 61 via the bridge member 68. The first carriage 66 is restricted from rotationally moving around the guide shaft (rotationally moving around the rotational axis θ) since the first rectilinear guide pin 66B is fitted to the rectilinear guide groove 61A.

The cam pin 66C is composed of a pin of which a distal end has a shape like a circular truncated cone. The cam pin 66C is fitted to the cam groove 54C provided at the rotational movement member 54. The cam groove 54C is provided in an inner peripheral surface of the rotational movement member body 54A. The cam groove 54C has a shape that causes the rotational movement member 54 to rotationally move in a predetermined angular range in a case where the cam pin 66C reciprocates in a predetermined distance range.

The second carriage 67 has a configuration in which the nut portion 67B and the second rectilinear guide pin 67C are integrally provided with a second carriage body 67A. The second carriage 67 is an example of a second sliding member.

The second carriage body 67A includes a guide hole 67a through which the guide shaft 63 passes. The second carriage 67 slides along the guide shaft 63 with the guide shaft 63 passing through the guide hole 67a.

The nut portion 67B is integrally provided with the second carriage body 67A, as a U-shaped groove portion of which an interior wall portion is composed of a female screw 67b. The nut portion 67B of the second carriage 67 is screw-bonded to the lead screw 62. Accordingly, in a case where the lead screw 62 is rotationally moved, the second carriage 67 is moved along the guide shaft 63.

The second rectilinear guide pin 67C is composed of a columnar pin. The second rectilinear guide pin 67C is fitted to the rectilinear guide groove 61A provided at the base frame 61 via the bridge member 68. The second carriage 67 is restricted from rotationally moving around the guide shaft (rotationally moving around the rotational axis θ) since the second rectilinear guide pin 67C is fitted to the rectilinear guide groove 61A.

The bridge member 68 is composed of an elongated plate including a first hole 68A and a second hole 68B.

The first hole 68A is a hole into which the first rectilinear guide pin 66B of the first carriage 66 is inserted. The first hole 68A is composed of a long hole extending in a longitudinal direction of the bridge member 68. The first rectilinear guide pin 66B is fitted to the rectilinear guide groove 61A through the first hole 68A.

The second hole 68B is a hole into which the second rectilinear guide pin 67C of the second carriage 67 is inserted. The second hole 68B is composed of a circular hole corresponding to the diameter of the second rectilinear guide pin 67C. The second rectilinear guide pin 67C is fitted to the rectilinear guide groove 61A through the second hole 68B.

In a case where the first rectilinear guide pin 66B is inserted into the first hole 68A and the second rectilinear guide pin 67C is inserted into the second hole 68B, the first carriage 66 and the second carriage 67 are connected to each other via the bridge member 68. Since the first hole 68A is composed of a long hole, the first carriage 66 is held to be movable with respect to the bridge member 68 within the range of the long hole. Meanwhile, since the second hole 68B is composed of a circular hole corresponding to the diameter of the second rectilinear guide pin 67C, the second carriage 67 is held to be substantially immovable with respect to the bridge member 68. Therefore, since the first carriage 66 and the second carriage 67 are connected to each other via the bridge member 68, the first carriage 66 is held to be relatively movable with respect to the second carriage 67 within the range of the first hole 68A which is a long hole. In other words, since the first carriage 66 and the second carriage 67 are connected to each other via the bridge member 68, the movable range of the first carriage 66 with respect to the second carriage 67 is relatively limited. The bridge member 68 is an example of a restriction member.

The compression spring 69 is disposed between the first carriage 66 and the second carriage 67 and biases the first carriage 66 and the second carriage 67 in directions away from each other. The compression spring 69 is an example of a biasing member.

In a case where the lock lever driving motor 64 of the lock lever driving unit 60 of the present example which is configured as described above is driven and the lead screw 62 is rotationally moved, the second carriage 67 linearly moves along the guide shaft 63 due to the action of the screw. In a case where the second carriage 67 is moved, the first carriage 66, which is connected to the second carriage 67 via the bridge member 68 and the compression spring 69, also linearly moves along the guide shaft 63. In addition, in a case where the first carriage 66 linearly moves, the rotational movement member 54 rotationally moves around the rotational axis θ due to the actions of the cam pin 66C provided at the first carriage 66 and the cam groove 54C provided at the rotational movement member 54. As a result, the lock lever 52 that is integrally provided with the rotational movement member 54 is rotationally moved around the rotational axis θ.

Here, regarding the lock lever driving unit 60 of the present example, the first carriage 66 is biased in a direction away from the second carriage 67 by the compression spring 69. Therefore, a force that causes the rotational movement member 54 to rotationally move in the engagement direction IN is applied to the rotational movement member 54 at all times. Accordingly, the lock lever 52 can be more reliably engaged with the claw portion 20D. Particularly, in a case where the recess portion of the lock lever 52 and/or the claw portion 20D is configured in a tapered shape, the engagement can be made more reliable.

In addition, it is possible to eliminate a backlash between the lead screw 62 and the nut portion 67B with the compression spring 69 biasing the first carriage 66 and the second carriage 67 therebetween. As a result, more stable driving can be realized.

In the case of the lock lever driving unit 60 of the present example as well, the lock lever 52 can be restrained from rotationally moving in a case where the lock lever driving motor 64 is in a non-electrified state.

The first clamping portion 52B1 of the lock lever 52 in the present example is an example of a fourth protruding portion and the second clamping portion 52B2 is an example of a fifth protruding portion. In addition, the claw portion 20D with which the lock lever 52 is engaged is an example of a sixth protruding portion.

### Other Modification Examples

In the above-described embodiment, the shape of the lock lever side that rotationally moves is a recessed shape and the shape of the claw portion side provided at the movable frame 20 is a protruding shape. However, the relationship therebetween may be reversed. That is, the shape of the lock lever side that rotationally moves may be a protruding shape and the shape of the claw portion side provided at the movable frame 20 may be a recessed shape.

### Second Embodiment

The focus lens unit 1 of the first embodiment has a configuration in which the claw portion 20D provided at the movable frame 20 is clamped by the first clamping portion 52B1 and the second clamping portion 52B2 of the lock lever 52 so that movement of the movable frame 20 is restricted.

In the present embodiment, the movable frame 20 is clamped by the lock lever 52 and an interior wall portion of the lens barrel 10 so that the movement of the movable frame 20 is restricted. More specifically, the movable frame 20 is clamped between the lock lever 52 and the interior wall portion of the front cover 10B so that the movement of the movable frame 20 is restricted.

Note that since the configurations other than the restriction mechanism are substantially the same as those in the first embodiment, only the restriction mechanism will be described below.

### [Configuration of Restriction Mechanism]

FIG. 22 is a view showing a configuration of a main part of the restriction mechanism.

As described above, the restriction mechanism 50 of the present embodiment restricts movement of the movable frame 20 by causing the movable frame 20 to be clamped between the lock lever 52 and an interior wall portion of the front cover 10B.

As shown in FIG. 22, a plurality of contact portions 10B1 that protrude in the extending direction of the optical axis Z are provided at the interior wall portion of the front cover 10B. Pads 10B2 (for example, rubber pads) composed of elastic bodies are provided on each of the contact portions 10B1. The pads 10B2 have a function as so-called dampers.

In a case where the movable frame 20 is moved to the front side (the object side), the movable frame 20 comes into contact with the contact portions 10B1 at a predetermined position (a third position) and forward movement of the movable frame 20 is restricted. A position at which the movable frame 20 comes into contact with the contact portions 10B1 will be referred to as the lock position. A predetermined portion of a front end surface of the movable frame 20 comes into contact with each of the pads 10B2 of the contact portions 10B1 at the lock position.

The restriction mechanism 50 restricts the movement of the movable frame 20 by causing the lock lever 52 (the first engagement portion) to be engaged with the claw portion 20D (the second engagement portion) of the movable frame 20 positioned at the lock position.

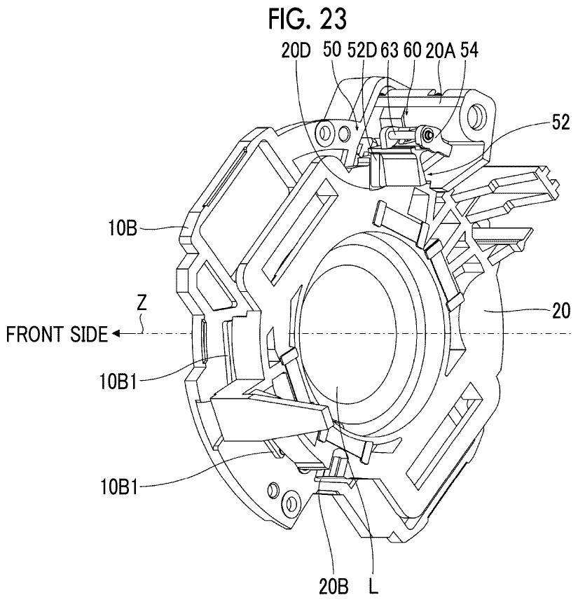

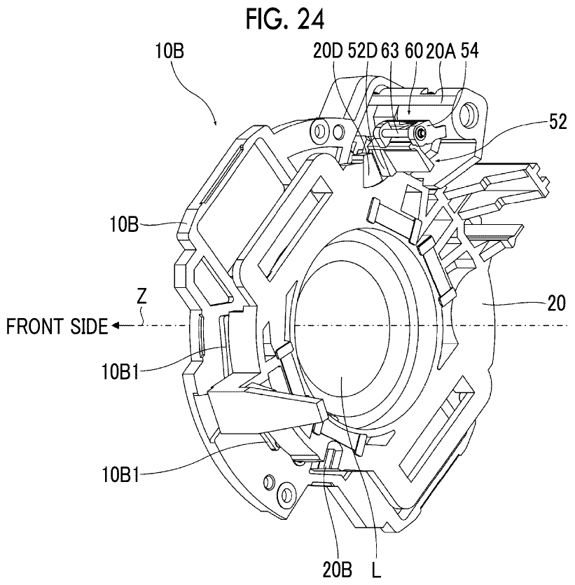

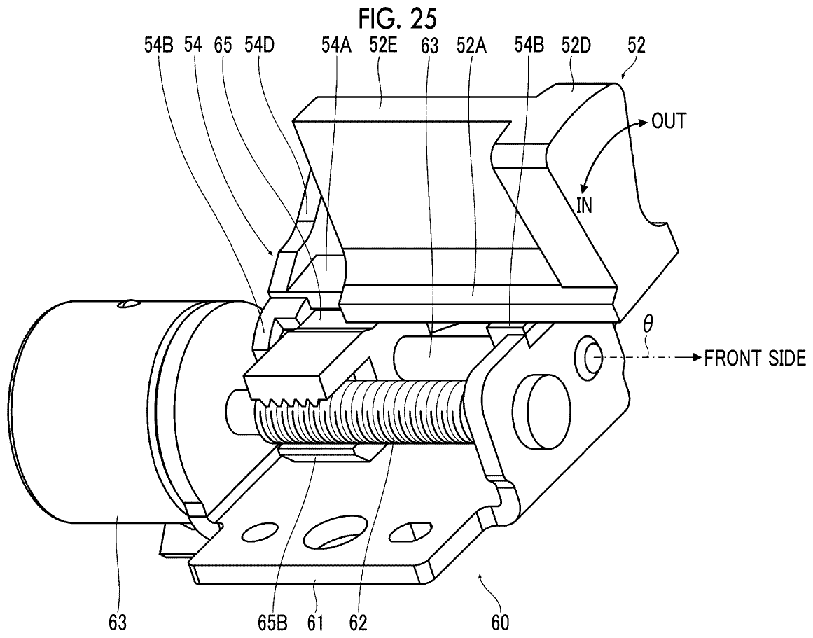

FIG. 23 is a view showing a state where movement of the movable frame is restricted by the lock lever. In addition, FIG. 24 is a view showing a state where the movable frame of which movement is restricted by the lock lever is released.

As shown in FIG. 23, the lock lever 52 is engaged with a rear surface of the claw portion 20D of the movable frame 20 positioned at the lock position, so that the movable frame 20 is clamped between the lock lever 52 and the front cover 10B.

In a case where the movable frame 20 restricted from moving is to be released, the lock lever 52 is withdrawn (separated) from the claw portion 20D as shown in FIG. 24.

FIG. 25 is a view showing configurations of the lock lever, the rotational movement member, and the lock lever driving unit.

The configurations of the rotational movement member 54 and the lock lever driving unit 60 are the same as the configurations thereof in the above-described first embodiment. Therefore, the configuration of the lock lever 52 will be described here.

The lock lever 52 is composed of the base portion 52A, an engagement portion 52D, and a rib portion 52E. The lock lever 52 is integrally provided with the rotational movement member 54.

The base portion 52A has a rectangular flat plate-like shape. The base portion 52A is integrally provided with the rotational movement member 54.

The engagement portion 52D is composed of a plate-like piece having a fan-like shape and is disposed to be orthogonal to the rotational axis θ. An arc-shaped portion of a distal end of the engagement portion 52D constitutes a part of a circle around the rotational axis θ. That is, the engagement portion 52D has a shape including an arc around the rotational axis θ in a cross section (a cross section intersecting the optical axis Z) orthogonal to the optical axis Z.

The rib portion 52E is a member that reinforces the engagement portion 52D on the base portion 52A and is disposed on a rear surface (a surface opposite to a surface that comes into contact with the claw portion 20D) of the engagement portion 52D. The rib portion 52E has a plate-like shape and is disposed on the base portion 52A along an extending direction of the rotational axis θ.

As described above, the lock lever 52 is integrally provided with the rotational movement member 54. Therefore, in a case where the rotational movement member 54 is rotationally moved, the lock lever 52 is also rotationally moved. The lock lever 52 and the rotational movement member 54 are formed of, for example, resin and are formed as an integrally molded product.

The lock lever 52 is rotationally moved around the rotational axis θ to move between the engagement position (a position shown in FIG. 23) and the separation position (a position shown in FIG. 24) by being driven by the lock lever driving unit 60.

### [Action of Restriction Mechanism]

Movement of the movable frame 20 is restricted as follows.

First, the movable frame 20 is moved to the lock position. In a case where the movable frame 20 is positioned at the lock position, the movable frame 20 comes into contact with the contact portions 10B1 provided at the interior wall portion of the front cover 10B. In this case, the movable frame 20 comes into contact with the contact portions 10B1 via the pads 10B2 provided at the contact portions 10B1. In addition, in a case where the movable frame 20 is positioned at the lock position, the claw portion 20D provided at the movable frame 20 is positioned at the installation position of the lock lever 52. More specifically, as shown in FIG. 24, the claw portion 20D is positioned at a position immediately ahead of the engagement portion 52D of the lock lever 52 in the extending direction of the optical axis Z.

After the movable frame 20 is positioned at the lock position, the lock lever driving unit 60 is driven such that the lock lever 52 is rotationally moved from the separation position (the second position) to the engagement position (the first position). Accordingly, as shown in FIG. 23, the engagement portion 52D of the lock lever 52 is engaged with the claw portion 20D. In this case, the engagement portion 52D is engaged with the claw portion 20D while causing elastic deformation of the pads 10B2 provided at the contact portions 10B1. In a case where the lock lever 52 is positioned at the engagement position, the engagement portion 52D of the lock lever 52 comes into contact with the rear surface of the claw portion 20D. Accordingly, movement of the movable frame 20 is restricted.

In a case where the movable frame 20 restricted from moving is to be released, the movable frame 20 is released as follows. That is, the lock lever driving unit 60 is driven such that the lock lever 52 is rotationally moved from the engagement position (the second position) to the separation position (the first position). Accordingly, the lock lever 52 is separated from the claw portion 20D and the lock lever 52 and the claw portion 20D are disengaged from each other. Accordingly, the movable frame 20 restricted from moving is released and the movable frame 20 becomes able to move.

As described above, in the present embodiment, the movable frame 20 is clamped between the lock lever 52 and the front cover 10B so that movement of the movable frame 20 is restricted.

### Modification Examples

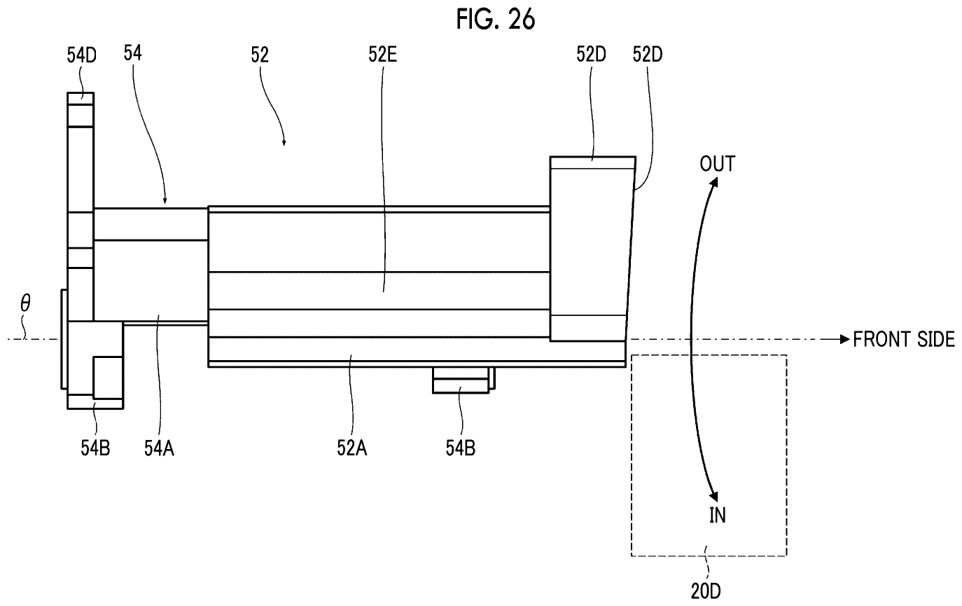

FIG. 26 is a view showing a modification example of the lock lever.

As shown in the drawing, in the case of the lock lever 52 of the present example, an engagement surface (a surface that is engaged with the claw portion 20D) 52D1 of the engagement portion 52D is composed of a tapered surface. More specifically, the engagement portion 52D is configured such that the width thereof decreases from the separation direction OUT toward the engagement direction IN, so that the engagement surface 52D1 is composed of an inclined tapered surface.

According to the above-described configuration, interference between the lock lever 52 and the claw portion 20D can be suppressed and the lock lever 52 can be smoothly engaged with the claw portion 20D.

Note that although the engagement surface 52D1 on the engagement portion 52D side is composed of a tapered surface in the present example, an engagement surface (a surface that is engaged with the engagement portion 52D) on the claw portion 20D side being composed of a tapered surface also results in the same effect. The engagement surface on the claw portion 20D side is the rear surface of the claw portion 20D.

### Other Modification Examples

Each modification example described in the first embodiment can also be applied to the restriction mechanism 50 of the present embodiment as appropriate. For example, the lock lever driving unit 60 having a configuration shown in FIG. 20 can be adopted. In addition, a pad composed of an elastic body can be provided at the engagement surface 52D1 of the engagement portion 52D.

### Other Embodiments

In the above-described embodiment, a case where the present invention is applied to a focus lens unit of a camera lens has been described as an example. However, the application of the present invention is not limited thereto. The present invention can be applied to a lens device including a movable frame and particularly to a lens device including a movable frame driven by a driving unit that allows free movement in a non-electrified state like a linear motor in general.

### [Supplementary Note]

Furthermore, a supplementary note as follows will be disclosed in relation to the above-described embodiment.

### (Supplementary Note 1)

A lens device comprising:
a lens barrel;
a movable frame that is movable in the lens barrel in an extending direction of an optical axis;
a first driving unit that drives the movable frame; and
a restriction mechanism that restricts movement of the movable frame,
wherein the restriction mechanism includes
   a first engagement portion that is rotationally movable between a first position and a second position around a rotational axis extending in the extending direction,
   a second engagement portion that is provided at the movable frame and that is engaged with the first engagement portion positioned at the first position, and
   a contact portion that is provided in the lens barrel and with which the movable frame positioned at a third position comes into contact, and
the first engagement portion is engaged with the second engagement portion with respect to the movable frame positioned at the third position, so that the movement of the movable frame is restricted.

### EXPLANATION OF REFERENCES

1: focus lens unit
10: lens barrel
10A: lens barrel body
10B: front cover
10B1: contact portion of front cover
10B2: pad
20: movable frame
20A: main guide portion
20B: sub-guide portion
20C: magnetic scale attachment portion
20D: Claw portion
20E: cutout portion
21: main shaft
22: sub-shaft
30: movable frame driving unit
30A: voice coil motor
30B: voice coil motor
31A: coil
31B: coil
32A: magnet
32B: magnet
33A: yoke
33B: yoke
40: position detection unit
41: reference position detection unit
41A: light blocking plate
41B: photointerrupter
42: movement amount detection unit
42A: magnetic scale
42B: MR sensor
50: restriction mechanism
52: lock lever
52A: base portion
52B: clamping portion
52B1: first clamping portion
52B2: second clamping portion
52C1: pad
52C2: pad
52D: engagement portion
52D1: engagement surface of engagement portion
52E: rib portion
54: rotational movement member
54A: rotational movement member body
54B: bearing portion
54b: hole of bearing portion
54C: cam groove
54D: light blocking plate
60: lock lever driving unit
61: base frame
61A: rectilinear guide groove
62: lead screw
63: guide shaft
64: lock lever driving motor
65: carriage
65A: carriage body
65a: guide hole of carriage body
65B: nut portion
65b: female screw of nut portion
65C: rectilinear guide pin
65D: cam pin
66: first carriage
66A: first carriage body
66a: guide hole of first carriage body
66B: first rectilinear guide pin
66C: cam pin
67: second carriage
67A: second carriage body
67a: guide hole of second carriage body
67B: nut portion
67b: female screw of nut portion
67C: second rectilinear guide pin
68: bridge member
68A: first hole of bridge member
68B: second hole of bridge member
69: compression spring
70: lock lever position detection unit
71: photointerrupter
L: lens group
Z: optical axis
RA1: chamfered portion of first clamping portion
RA2: chamfered portion of second clamping portion
RB1: chamfered portion of first clamping portion
RB2: chamfered portion of second clamping portion
θ: rotational axis
IN: engagement direction
OUT: separation direction

What is claimed is:

1. A lens device comprising:
a movable frame that is formed of resin and is movable in an extending direction of an optical axis;
a first driving unit that drives the movable frame; and
a restriction mechanism that restricts movement of the movable frame,
wherein the restriction mechanism includes
a rotational movement member that is formed of resin and is rotationally movable between a first position and a second position around a rotational axis extending in the extending direction,
a first engagement portion which is provided at one of the movable frame or the rotational movement member and has a recessed shape, in which a width of a recess portion is increasable and decreasable by elastic deformation of the resin, and
a second engagement portion that is provided at the other of the movable frame or the rotational movement member, has a protruding shape, and is pressed into the recess portion to be engaged with the first engagement portion,
the first position is a position at which the first engagement portion and the second engagement portion are separated from each other, and
the second position is a position at which the first engagement portion is engaged with the second engagement portion while being elastically deformed.

2. The lens device according to claim 1,
wherein the first driving unit is a driving unit that allows the movable frame to move freely in a case of a non-electrified state.

3. The lens device according to claim 1,
wherein the first driving unit is a linear motor.

4. The lens device according to claim 1,
wherein the first position is a position in a case of an electrified state of the first driving unit, and
the second position is a position in a case of a non-electrified state of the first driving unit.

5. The lens device according to claim 1,
wherein the first position is a position at which the movable frame restricted from moving is released, and
the second position is a position at which the movement of the movable frame is restricted.

6. The lens device according to claim 1, further comprising:
a second driving unit that rotationally moves the rotational movement member.

7. The lens device according to claim 1,
wherein, in a case where the rotational movement member is rotationally moved from the first position to the second position, the second engagement portion is engaged with the first engagement portion with the first engagement portion being elastically deformed and thus the restriction mechanism restricts the movement of the movable frame and in a case where the rotational movement member is rotationally moved from the second position to the first position, the second engagement portion is separated from the first engagement portion with the first engagement portion being elastically deformed and thus the restriction mechanism releases the movable frame restricted from moving.

8. The lens device according to claim 1,
wherein the first engagement portion is provided at the rotational movement member, and
the second engagement portion is provided at the movable frame.

9. The lens device according to claim 1,
wherein the movable frame includes
a first guide portion that slides in a first axial direction extending in the extending direction and that guides the movement of the movable frame, and
a second guide portion that slides in a second axial direction extending in the extending direction and that assists in guidance performed by the first guide portion, and
the first engagement portion or the second engagement portion is provided relatively closer to the first guide portion than to the second guide portion.

10. The lens device according to claim 1,
wherein each of portions of the first engagement portion and the second engagement portion at which the first engagement portion and the second engagement portion are engaged with each other has a shape including an arc around the rotational axis of the rotational movement member in a cross section intersecting the optical axis.

11. The lens device according to claim 1,
wherein the first engagement portion includes a first protruding portion and a second protruding portion which are disposed at an interval in the extending direction to form the recess portion, and elastically deform in the extending direction to increase and decrease the width, and
the second engagement portion includes a third protruding portion which is pressed into the recess portion to be engaged with the first protruding portion and the second protruding portion.

12. The lens device according to claim 11,
wherein a width of the third protruding portion in the extending direction is larger than the interval.

13. The lens device according to claim 11,
wherein each of the first protruding portion and the second protruding portion has a shape of which a width in the extending direction decreases from the rotational axis toward an outer side.

14. The lens device according to claim 11,
wherein surfaces of the first protruding portion and the second protruding portion that face each other are inclined such that the interval becomes greater from the second position toward the first position.

15. The lens device according to claim 14, further comprising:
a biasing member or a biasing mechanism that biases the rotational movement member in a direction from the first position toward the second position.

16. The lens device according to claim 11,
wherein the third protruding portion has a shape of which a width decreases in a direction from the first position toward the second position.

17. The lens device according to claim 16, further comprising:
a biasing member or a biasing mechanism that biases the rotational movement member in a direction from the first position toward the second position.

18. The lens device according to claim 11,
wherein corner portions of the first protruding portion and the second protruding portion that come into contact with the third protruding portion include chamfered portions.

19. The lens device according to claim 11,
wherein end portions of the first protruding portion and the second protruding portion that are on a movable frame side or a rotational movement member side include chamfered portions.

20. The lens device according to claim 11,
wherein at least one of the first protruding portion or the second protruding portion includes an elastic member.

21. A lens device comprising:
a movable frame that is movable in an extending direction of an optical axis;
a first driving unit that drives the movable frame; and
a restriction mechanism that restricts movement of the movable frame,
wherein the restriction mechanism includes:
a rotational movement member that is rotationally movable between a first position and a second position around a rotational axis extending in the extending direction;
a second driving mechanism that rotates the rotational movement member;
a first engagement portion that is provided at one of the movable frame or the rotational movement member and that is elastically deformed; and
a second engagement portion that is provided at the other of the movable frame or the rotational movement member and that is engaged with the first engagement portion,
the first position is a position at which the first engagement portion and the second engagement portion are separated from each other,
the second position is a position at which the first engagement portion is engaged with the second engagement portion while being elastically deformed,
the second driving unit includes:
a cam groove that is provided at the rotational movement member,
a screw member that is disposed to extend in the extending direction,
an actuator that rotationally drives the screw member;
a sliding member that slides in the extending direction;
a nut portion that is provided at the sliding member and that is screw-bonded to the screw member; and
a cam pin that is provided at the sliding member and that is engaged with the cam groove, and
a linear motion of the sliding member is converted into a rotational motion by means of the cam pin and the cam groove so that the rotational movement member is rotationally moved.

22. A lens device comprising:
a movable frame that is movable in an extending direction of an optical axis;
a first driving unit that drives the movable frame; and
a restriction mechanism that restricts movement of the movable frame,
wherein the restriction mechanism includes:
a rotational movement member that is rotationally movable between a first position and a second position around a rotational axis extending in the extending direction;
a second driving mechanism that rotates the rotational movement member;
a first engagement portion that is provided at one of the movable frame or the rotational movement member and that is elastically deformed; and
a second engagement portion that is provided at the other of the movable frame or the rotational movement member and that is engaged with the first engagement portion,
the first position is a position at which the first engagement portion and the second engagement portion are separated from each other,
the second position is a position at which the first engagement portion is engaged with the second engagement portion while being elastically deformed,
the second driving unit includes:
a cam groove that is provided at the rotational movement member;
a screw member that is disposed to extend in the extending direction;
an actuator that rotationally drives the screw member;
a first sliding member that slides in the extending direction;
a second sliding member that slides in the extending direction;
a restriction member that is engaged with the first sliding member and the second sliding member and that restricts a movable range of the first sliding member with respect to the second sliding member;
a cam pin that is provided at the first sliding member and that is engaged with the cam groove;
a nut portion that is provided at the second sliding member and that is screw-bonded to the screw member; and
a biasing member that is provided between the first sliding member and the second sliding member and that biases the first sliding member and the second sliding member in directions away from each other, and
a linear motion of the first sliding member is converted into a rotational motion by means of the cam pin and the cam groove so that the rotational movement member is rotationally moved.

23. The lens device according to claim 22,
wherein the first engagement portion includes a fourth protruding portion and a fifth protruding portion that are disposed at an interval in the extending direction, and
surfaces of the fourth protruding portion and the fifth protruding portion that face each other are inclined such that an interval between the surfaces facing each other becomes greater from the first position toward the second position.

24. The lens device according to claim 22,
wherein the second engagement portion includes a sixth protruding portion that is engaged with the first engagement portion, and
the sixth protruding portion has a shape of which a width decreases in a direction from the first position toward the second position.
